(19) United States
(12) Patent Application Publication
(10) Pub. No.: US 2008/0005800 A1
(43) Pub. Date: Jan. 3, 2008

(54) Confidential information protection system, confidential information restoring device, and tally generating device

(76) Inventors: Kaoru Yokota, Hyogo (JP); Shunji Harada, Osaka (JP); Motoji Ohmori, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/806,943

(22) Filed: Jun. 5, 2007

(30) Foreign Application Priority Data
Jun. 7, 2006 (JP) 2006-158183

(51) Int. Cl. G06F 12/14

(52) U.S. Cl. 726/26

(57) ABSTRACT

A tally generating device 10 generates a plurality of pieces of tally data, based on confidential information S and tally generation instruction information. The tally data includes tally main data and tally sub data, and the tally sub data indicates a condition relating to restoration of the confidential information S in each of confidential information restoring devices. When restoring the confidential information S, each of the confidential information restoring devices collects the required number of pieces of tally data, and judges whether or not the restoration of the confidential information S is permitted, based on the tally sub data. When judging that “Restoration is permitted”, each of the confidential information, restoring devices restores the confidential information S, and when judging that “Restoration is not permitted”, each of the confidential information restoring devices cannot restore the confidential information S.

This application is based on an application No. 2006-158183 filed in Japan, the content of which is hereby incorporated by reference.

### BACKGROUND OF THE INVENTION

(1) Field of the Invention

The present invention relates to a technology for protecting confidential information using a secret sharing scheme, and especially to a technology for improving security of confidential information.

(2) Related Art

A patent document 1 discloses a technology for protecting confidential information using the secret sharing scheme.

In the secret sharing scheme, N pieces of data (hereinafter, referred to as an “electronic tally”) are generated from confidential information, and the generated N electronic tallies are divided and shared by a plurality of terminal devices. The secret sharing scheme has the following feature. The confidential information can be restored using K (≦N) electronic tallies out of the N electronic tallies that are divided and shared by the plurality of terminal devices, but cannot be restored using less than K electronic tallies.

Also, a patent document 2 discloses a technology for improving confidentiality of confidential information by sharing management information for managing a storage area of an electronic tally.

In the above-mentioned conventional technology, any terminal device that has a function of restoring confidential information from electronic tallies can restore confidential information if it collects the number of electronic tallies required for the restoration, with disregard to a processing capacity of the terminal device, reliability of a user who owns the terminal device, or the like. Such a conventional technology lacks security from a viewpoint of confidentiality protection of the confidential information.

Patent Document 1: Japanese Published Patent Application No. 2002-351845

Patent Document 2: Japanese Published Patent Application No. 2004-147218

### SUMMARY OF THE INVENTION

In view of the above problem, an object of the present invention is to provide a confidential information protection system, a confidential information restoring device, and a tally generating device for improving security in protection of confidential information.

The above-mentioned object can be achieved by a confidential information protection system that includes a tally generating device and a plurality of terminal devices, and divides up and holds confidential information among the plurality of terminal devices, the tally generating device comprising: a tally generation unit operable to generated plurality of electronic tallies from the confidential information; and a restoration control information generation unit operable to generate, for each of the plurality of terminal devices, restoration control information that indicates a condition relating to restoration of the confidential information by the terminal device, and each of the plurality of terminal devices comprising: a storage unit operable to store therein one of the plurality of electronic tallies and the corresponding restoration control information generated by the tally generating device; a tally collection unit operable to collect a required number of electronic tallies; a judgment unit operable to judge whether or not the restoration of the confidential information is permitted, based on the corresponding restoration control information; and a restoration unit operable to, only when the judgment unit judges that the restoration of the confidential information is permitted, restore the confidential information from the one of the plurality of electronic tallies stored in the storage unit and the required number of electronic tallies collected by the tally collection unit.

With the above-stated construction, the tally generating device distributes the electronic tally and the restoration control information to each of the plurality of terminal devices. Therefore, there may be a case in which each of the plurality of terminal devices cannot restore the confidential information even if obtaining the required umber of electronic tallies for restoration, because of the judgment result of whether or not the restoration of the confidential information is permitted, which uses the restoration control information. For example, the restoration control information is information indicating permission/non-permission of the restoration, information indicating processing performance that is required for a terminal device, or the like.

The present invention can properly manage a terminal device that restores confidential information, and protect confidential information with high security, by judging whether or not the restoration of the confidential information is permitted, based on the above-mentioned restoration control information.

Also, the present invention is a confidential information restoring device for restoring confidential information from a plurality of electronic tallies that are generated from the confidential information, the confidential information restoring device comprising: a storage unit operable to store therein one of the plurality of electronic tallies and restoration control information generated by a tally generating device, the restoration control information indicating a condition relating to restoration of the confidential information; a tally collection unit operable to collect a required number of electronic tallies; a judgment unit operable to judge whether or not the restoration of the confidential information is permitted, based on the restoration control information stored in the storage unit; and a restoration unit operable to, only when the judgment unit judges that the restoration of the confidential information is permitted, restore the confidential information from the one of the plurality of electronic tallies stored in the storage unit and the required number of electronic tallies collected by the tally collection unit.

With the above-stated construction, the confidential information restoring device judges whether or not the restoration of the confidential information is permitted, based on the restoration control information, even if collecting the required number of electronic tallies. When being judged that the restoration of the confidential information is not permitted, the confidential information restoring device cannot perform the restoration process of the confidential information. As a result, confidential information can be protected with high security.

Here, the tally collection unit obtains, from each of a same number of other confidential information restoring devices as the required number, an electronic tally and restoration control information which the other confidential information restoring device acquired from the tally generating device, and the restoration unit restores the confidential information using the one of the plurality of electronic tallies and the restoration control information stored in the storage unit, and the electronic tally and the restoration control information obtained by the tally collection unit.

With the above-stated construction, the confidential information cannot be restored only by using the electronic tally. The confidential information can be restored by using not only the electronic tally but also the restoration control information. In other words, since the electronic tally is information relating to the restoration control information, the confidential information restoring device cannot restore the correct confidential information unless both the electronic tally and the restoration control information are correct pieces of information. Also, it is obvious that the confidential information restoring device cannot restore the correct confidential information when obtaining only the electronic tally.

Here, information that indicates whether or not to permit the restoration of the confidential information is set in the restoration control information stored in the storage unit, and the judgment unit judges that the restoration of the confidential information is permitted when the restoration control information indicates permission of the restoration, and judges that the restoration of the confidential information is not permitted when the restoration control information indicates non-permission of the restoration.

With the above-stated construction, when the restoration control information indicates non-permission of the restoration, the confidential information restoring device is prohibited to restore the confidential information even if collecting the required number of electronic tallies. Therefore, if comparing with a conventional restoring device from a viewpoint of confidential information protection, the present invention can realize confidential information protection with higher security.

Here, information that indicates a characteristic of a device that is permitted to restore the confidential information is set in the restoration control information stored in the storage unit, and the confidential information restoring device further comprises: a device characteristic storage unit operable to store device characteristic information that indicates a characteristic of the confidential information restoring device, wherein the judgment unit reads the device characteristic information, judges that the restoration of the confidential information is permitted when the read device characteristic information satisfies the characteristic indicated by the restoration control information, and judges that the restoration of the confidential information is not permitted when the read device characteristic information does not satisfy the characteristic indicated by the restoration control information.

With the above-stated construction, the confidential information restoring device is prohibited to restore the confidential information when the device characteristic thereof does not satisfy the device characteristic indicated by the restoration control information. Therefore, if comparing with a conventional restoring device from a viewpoint of confidential information protection, the present invention can realize confidential information protection with higher security.

Here, the characteristic indicated by the restoration control information indicates processing performance that is required for the restoration of the confidential information, and the device characteristic information indicates processing performance of the confidential information restoring device.

With the above-stated construction, when the confidential information restoring device dose not have the required performance for the restoration process of the confidential information, the confidential information restoring device is prohibited to restore the confidential information. In other words, the present invention can prohibit the restoration of the confidential information when it is not ensured that the confidential information is correctly restored.

Here, the judgment unit compares the restoration control information stored in the storage unit with the restoration control information obtained by the tally collection unit to perform the judgment.

With the above-stated construction, the confidential information restoring device judges whether or not the restoration of the confidential information is permitted, by also using the restoration control information of other confidential information restoring device. Therefore, in the system in which the confidential information is divided and shared by a plurality of confidential information restoring devices, the proper confidential information restoring devices out of the plurality of confidential information restoring devices are judged that the restoration of the confidential information is permitted.

Here, information that indicates a priority of performing the restoration of the confidential information in a plurality of confidential information restoring devices that hold the plurality of electronic tallies is set in the restoration control information stored in the storage unit, and the judgment unit judges that the restoration of the confidential information is permitted when the priority indicated by the restoration control information stored in the storage unit is higher than a priority indicated by the restoration control information obtained by the tally collection unit, and judges that the restoration of the confidential information is not permitted when the priority indicated by the restoration control information stored in the storage unit is lower than the priority indicated by the restoration control information obtained by the tally collection unit.

With the above-stated construction, the confidential information restoring device is prohibited to restore the confidential information when the priority thereof is set to be lower than the priority of other confidential information restoring device. Here, when the priority is set based on reliability of the confidential information restoring device itself, reliability of a user who owns the confidential information restoring device, or the like, it is possible to prohibit a confidential information restoring device and a user that have low reliability from restoring the confidential information.

Here, the confidential information restoring device further comprises a restoration control information update unit operable to, when the judgment unit judges that the restoration of the confidential information is permitted, update the priority indicated by the restoration control information stored in the storage unit.

With the above-stated construction, since the restoration control information is updated, high and low of the priority between the confidential information restoring devices is varied in accordance with the restoration of the confidential information. Therefore, a case, in which only a certain confidential information restoring device is permitted to perform the restoration process of the confidential information every time, can be prevented, and a plurality of confidential information restoring devices can evenly perform the restoration process.

Here, the confidential information restoring device receives a tampering detection value from the tally generating device, the tampering detection value being generated by performing a predetermined operation on the restoration control information, wherein the judgment unit judges whether the restoration control information has been tampered with, by using the tampering detection value, and judges that the restoration of the confidential information is not permitted when the tampering of the restoration control information is detected.

Because the restoration control information in the present invention is information for controlling whether or not to permit restoration of the confidential information in order to protect the security of the confidential information, reliability of the information itself is important. Therefore, with the above-stated construction, it can be prevented that the restoration permission/non-permission judgment process is performed based on the wrong restoration control information that is tampered.

Here, each of the plurality of electronic tallies is information generated by performing a secret sharing scheme that uses a plurality of pieces of restoration control information on the confidential information, and the restoration unit restores the confidential information from the plurality of electronic tallies, using the restoration control information stored in the storage unit and the restoration control information obtained by the tally collection unit.

In the case of the construction in which the restoration process is controlled using the restoration control information, it can be assumed to be suffered from an attack in which a wrong confidential information restoring device can restore the confidential information by tampering the restoration control information.

However, with the above-stated construction, because the electronic tally is information that is generated by performing the secret sharing scheme using the restoration control information on the confidential information, even if the restoration control information is tampered and the restoration permission/non-permission judgment process is performed, the wrong confidential information restoring device cannot restore the correct confidential information in the subsequent restoration process of the confidential information. Therefore, an attack that tampers the restoration control information can be disabled.

Here, the confidential information restoring device further comprises a data control unit operable to, when the judgment unit judges that the restoration of the confidential information is not permitted, discard the required number of electronic tallies collected by the tally collection unit.

With the above-stated construction, by discarding the electronic tally that is obtained from the other confidential information restoring device, it is prevented that the confidential information is restored because of an erroneous operation by a user or the like. As a result, the restoration of the confidential information can be certainly prohibited.

Here, the tally collection unit collects the required number of electronic tallies when the judgment unit judges that the restoration of the confidential information is permitted.

With the above-stated construction, when judged that “Restoration is not permitted”, the confidential information restoring device suppresses unnecessary transmission/reception of data, and can reduce an amount of data that is transmitted or received between the confidential information restoring devices.

Also, the present invention is a tally generating device comprising: a tally generation unit operable to generate a plurality of electronic tallies from confidential information; a restoration control information generation unit operable to generate, for each of a plurality of terminal devices that are distribution targets of the plurality of electronic tallies, restoration control information that indicates a condition relating to restoration of the confidential information by the terminal device; and a distribution unit operable to distribute each of the plurality of electronic tallies and the corresponding restoration control information to each of the terminal devices.

With the above-stated construction, the tally generating device can set a condition of restoration in the confidential information restoring device that is a distribution target of the electronic tally. Therefore, confidential information protection with higher security can be realized compared with a case in which the restoration of the confidential information is permitted without any condition.

Here, the restoration control information generation unit generates the restoration control information based on a number of the plurality of electronic tallies to be generated, a required number of electronic tallies for the restoration of the confidential information, and tally generation instruction information including the condition, and the tally generation unit generates the plurality of electronic tallies based on the confidential information, the tally generation instruction information, and the restoration control information.

With the above-stated construction, the tally generating device generates the electronic tally based on the restoration control information. Therefore, it can be prevented that the restoration control information that has been generated once, is tampered by a wrong user. This is because the correct confidential information cannot be restored using the tampered restoration control information.

Here, the restoration control information generation unit generates the restoration control information that indicates whether or not to permit the restoration of the confidential information in each of the plurality of terminal devices.

With the above-stated construction, whether or not the restoration of the confidential information is permitted can be individually set in each of the plurality of confidential information restoring devices that divide and share the confidential information.

Here, the restoration control information generation unit generates the restoration control information that indicates a priority of the restoration of the confidential information in each of the plurality of terminal devices.

With the above-stated construction, the tally generating device of the present invention sets priorities in the plurality of confidential information restoring devices, and realizes the control of the restoration of the confidential information in accordance with the priorities. For example, by setting the priority based on reliability of the confidential information restoring device itself, reliability of a user who owns the confidential information restoring device, or the like, it is possible to prohibit a confidential information restoring device and a user that have low reliability from restoring the confidential information. Therefore, if comparing with a conventional tally generating device from a viewpoint of security protection of the confidential information, the present invention can realize confidential information protection with higher security.

Here, the restoration control information generation unit generates the restoration control information that indicates a characteristic of a device that is permitted to restore the confidential information.

With the above-stated construction, the tally generating device can realize the control of the restoration of the confidential information in view of the device characteristic of each of the confidential information restoring devices.

Here, the characteristic indicated by the restoration control information is processing performance that is required for the restoration of the confidential information.

With the above-stated construction, the tally generating device can prohibit the following confidential information restoring device from restoring the confidential information. The confidential information restoring device does not have performance that is required for the restoration process of the confidential information, i.e. the confidential information restoring device is not assured that the confidential information is correctly restored.

Here, the restoration control information generation unit generates the restoration control information which is a value of the required number of electronic tallies for the restoration of the confidential information included in the tally generation instruction information.

In the secret sharing scheme in which the electronic tally is generated from the confidential information, and the generated electronic tally is divided and shared by the plurality of confidential information restoring devices, a calculation amount required for the restoration process is different in accordance with a value of the number (restoration threshold value) of electronic tallies required for the restoration of the confidential information. Therefore, in the present invention, processing performance of the confidential information restoring device that is required for the restoration of the confidential information can be expressed in the value of the restoration threshold value. As a result, the tally generating device can determine that the existing data is the restoration control information.

Here, the tally generating device further comprises a tampering detection value generation unit operable to perform a predetermined operation on the restoration control information to generate a tampering detection value corresponding to the restoration control information, wherein the distribution unit distributes the tampering detection value, in addition to each of the plurality of electronic tallies and the restoration control information, to each of the plurality of terminal devices.

Because the restoration control information in the present invention is information for controlling whether or not to permit the restoration of the confidential information in order to protect the security of the confidential information, reliability of the information itself is important. Therefore, with the above-stated construction, it can be prevented that the restoration permission/non-permission judgment process is performed based on the wrong restoration control information that is tampered because the tally generating device transmits the tampering detection value to the confidential information restoring device.

Here, the tally generation unit generates the plurality of electronic tallies based on the plurality of pieces of restoration control information generated by the restoration control information generation unit and the confidential information.

Also, the tally generation unit performs a secret sharing scheme that uses the plurality of pieces of restoration control information on the confidential information to generate the plurality of electronic tallies.

In the case of the construction in which the restoration process is controlled using the restoration control information, it can be assumed to be suffered from an attack in which a wrong confidential information restoring device can restore the confidential information by tampering the restoration control information.

However, with the above-stated construction, because the electronic tally generated by the tally generating device is information that is generated by performing the secret sharing scheme using the restoration control information on the confidential information, even if the restoration control information is tampered and the restoration permission/non-permission judgment process is performed, the wrong confidential information restoring device cannot restore the correct confidential information in the subsequent restoration process of the confidential information. Therefore, an attack that tampers the restoration control information can be disabled.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a diagram showing a system structure of a confidential information protection system 1;

FIG. 2 is a functional block diagram functionally showing a structure of a tally generating device 10;

FIG. 3 is a diagram showing a data structure of tally generation instruction information 110;

FIG. 4 is a diagram showing a data structure of tally restoration permission information 131;

FIG. 5 is a diagram describing concrete examples of tally restoration permission rule information and significant information included in each tally restoration permission information;

FIG. 6 is a diagram showing a data structure of tally main data generation control information 210;

FIG. 7 is a diagram showing a data structure of tally sub data generation control information 220;

FIG. 8 is a diagram showing a data structure of tally transmission destination information 230;

FIG. 9 is a functional block diagram functionally showing a structure of a tally main data generation unit;

FIG. 10 is a diagram showing a data structure of tally data W₁ (240);

FIG. 11 is a flowchart showing an operation of a tally data generation process;

FIG. 12 is a flowchart showing an operation of a tally main data generation process;

FIG. 13 is a functional block diagram functionally showing a structure of a confidential information restoring device 21;

FIG. 14 is a diagram showing data stored in a device identification information storage unit 204;

FIG. 15 is a diagram showing data stored in a device characteristic information storage unit 205;

FIG. 16 is a flowchart showing an operation of a confidential information restoration process followed by FIG. 17;

FIG. 17 is a flowchart showing an operation of a confidential information restoration process following FIG. 16;

FIG. 18 is a flowchart showing an operation of a restoration permission/non-permission judgment process 1;

FIG. 19 is a flowchart showing an operation of a restoration permission/non-permission judgment process 2;

FIG. 20 is a flowchart showing an operation of a restoration permission/non-permission judgment process 3;

FIG. 21 is a flowchart showing an operation of a restoration permission/non-permission judgment process 4; and

FIG. 22 is a flowchart showing an operation of a confidential information restoration process.

### DESCRIPTION OF THE PREFERRED EMBODIMENT

The following describes a confidential information protection system 1 of an embodiment of the present invention, with reference to the attached drawings.

Outline

Here, an outline of the confidential information protection system 1 will be described.

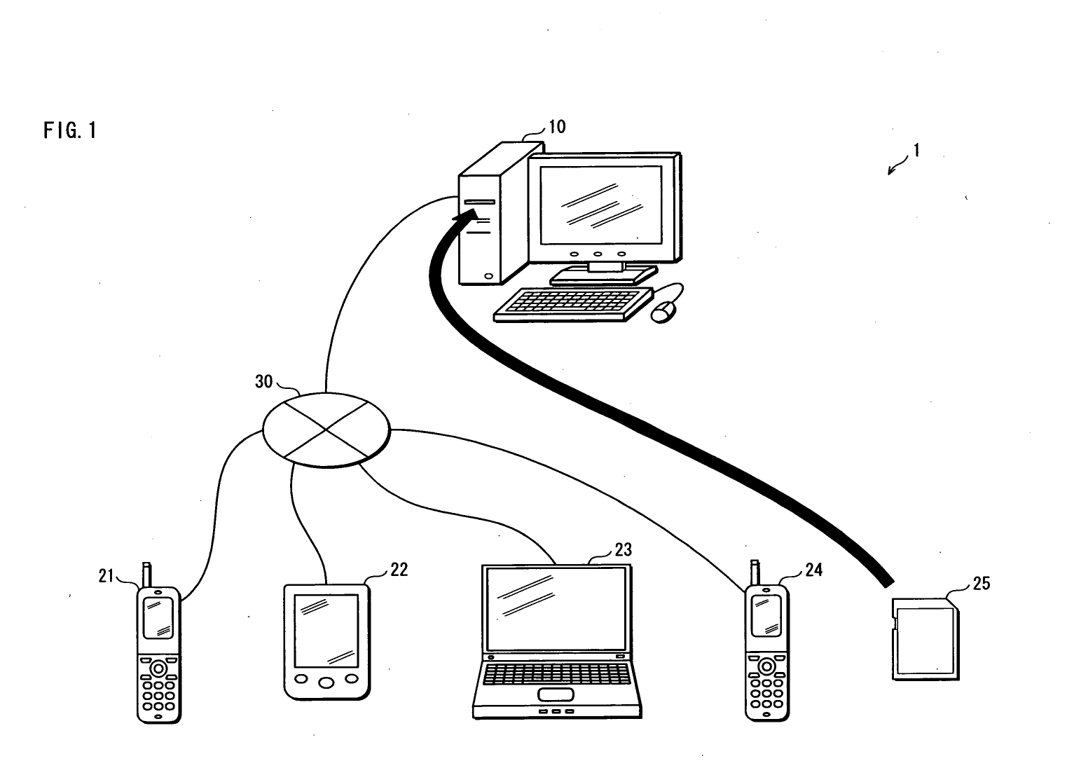

FIG. 1 is a diagram showing a structure of the confidential information protection system 1. As shown in FIG. 1, the confidential information protection system 1 includes a tally generating device 10 and five confidential information restoring devices 21, 22, 23, 24, and 25.

In this embodiment, as a concrete example, the tally generating device 10 is a personal computer, the confidential information restoring devices 21 and 24 are mobile phones, the confidential information restoring device 22 is a PDA (Personal Digital Assistant), the confidential information restoring device 23 is a laptop computer, and the confidential information restoring device 25 is a memory card that is used by being inserted in the tally generating device 10 and other confidential information restoring devices.

The tally generating device 10 and the confidential information restoring devices 21, 22, 23, 24, and 25a reconnected to each other via a network 30, and transmit/receive information via the network 30.

In this embodiment, the number of confidential information restoring devices is five. However, the number of confidential information restoring devices is not limited to five, and varies according to how many confidential information restoring devices divide and share confidential information S.

The tally generating device 10 generates five pieces of tally main data based on the confidential information S and tally generation instruction information that will be described later, using the secret sharing scheme. Also, the tally generating device 10 generates five pieces of tally sub data including a condition relating to the restoration of the confidential information S in each of the confidential information restoring devices.

The tally generating device 10 distributes tally data that is composed of tally main data and tally sub data to each of the confidential information restoring devices 21, 22, 23, 24, and 25.

When restoring the confidential information S from the tally data, each of the confidential information restoring devices collects the required number of pieces of tally data for the restoration of the confidential information S, and then judges whether or not the restoration of the confidential information S is permitted by using tally sub data.

When judging that the restoration of the confidential information S is permitted as a result of the judgment, each of the confidential information restoring devices restores the confidential information S. On the other hand, when judging that the restoration of the confidential information S is not permitted, each of the confidential information restoring devices does not restore the confidential information S, and discards tally data obtained from other confidential information restoring devices.

Structure of Tally Generating Device 10

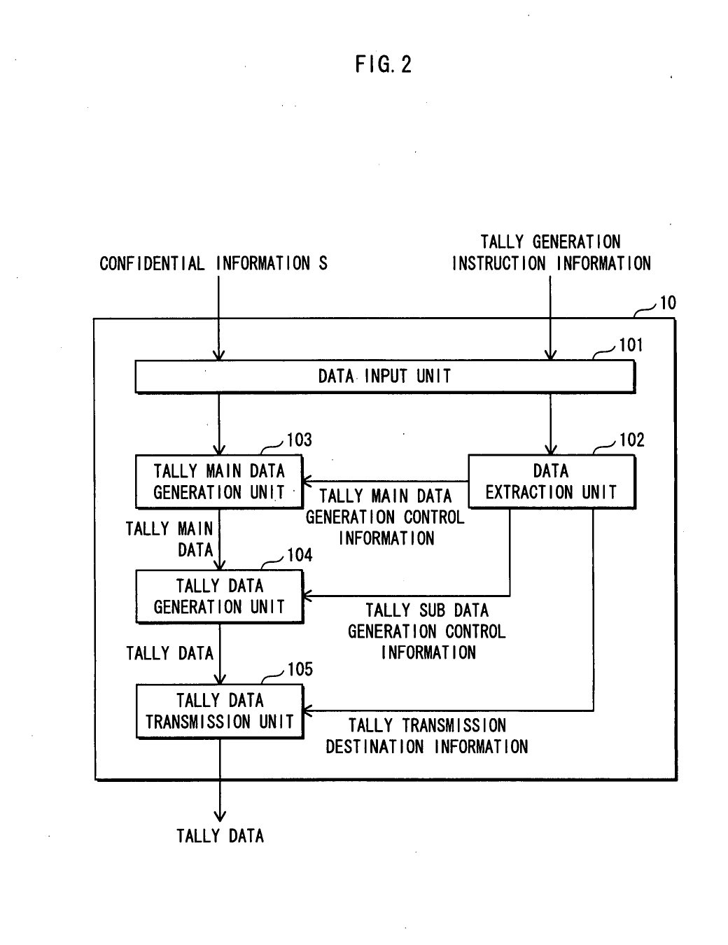

FIG. 2 is a functional block diagram showing a functional structure of the tally generating device 10. As shown in FIG. 2, the tally generating device 10 includes a data input unit 101, a data extraction unit 102, a tally main data generation unit 103, a tally data generation unit 104, and a tally data transmission unit 105.

More specifically, the tally generating device 10 is a computer system that is composed of a microprocessor, a ROM, a RAM, a hard disk unit, a network connection unit, or the like. The tally generating device 10 fulfills a function thereof by the microprocessor operating in accordance with a computer program.

(1) Data Input Unit 101.

The data input unit 101 receives a data input from outside. More specifically, the data input unit 101 receives an input of the confidential information S and the tally generation instruction information.

The confidential information S is information that requires confidentiality, such as an address book, sent/received mail, or other personal information, business secret information including customer information, in-house product information, sale record information, or key information for decrypting encrypted content or the like. The contents of the confidential information S are not limited in the present invention.

(Data Structure of Tally Generation Instruction Information)

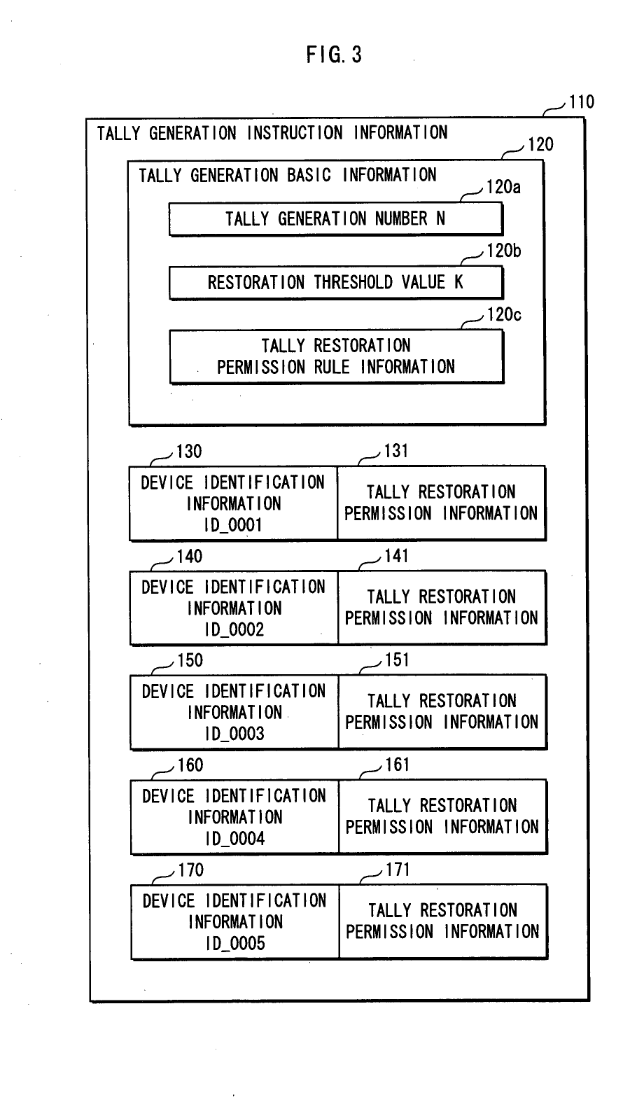

FIG. 3 shows a concrete example of the tally generation instruction information.

Tally generation instruction information 110 shown in FIG. 3 includes tally generation basic information 120 and five pairs of device identification information and tally restoration permission information.

More specifically, the five pairs of device identification information and tally restoration permission information are: device identification information ID_0001 (130) and tally restoration permission information 131; device identification information ID_0002 (140) and tally restoration permission information 141; device identification information ID_0003 (150) and tally restoration permission information 151; device identification information ID_0004 (160) and tally restoration permission information 161; and device identification information ID_0005 (170) and tally restoration permission information 171.

The tally generation basic information 120 includes a tally generation number N (120a), a restoration threshold value K (120b), and tally restoration permission rule information 120c.

The tally generation number N is information indicating how many pieces of tally data are to be generated from the confidential information S. In this embodiment, because the number of confidential information restoring devices is five, the number of pieces of tally data to be generated is five. Therefore, N=5. In this case, the tally generation instruction information 110 includes N (=5) pairs of device identification information and tally restoration permission information.

The restoration threshold value K is information indicating how many pieces of tally data are required to restore the confidential information S. In this embodiment, K=3 as an example.

The tally restoration permission rule information 120c indicates one of a rule 1, a rule 2, a rule 3, and a rule 4. The tally restoration permission rule information 120c shows one of the rules 1 to 4 based on which the tally restoration permission information 131, 141, 151, 161, and 171 have been set. Details of each of the rules will be described later.

The device identification information is an identifier for identifying a confidential information restoring device. In detail, the device identification information ID_0001 (130) is an identifier of the confidential information restoring device 21. The device identification information ID_0002 (140) is an identifier of the confidential information restoring device 22. The device identification information ID_0003 (150) is an identifier of the confidential information restoring device 23. The device identification information ID_0004 (160) is an identifier of the confidential information restoring device 24. The device identification information ID_0005 (170) is an identifier of the confidential information restoring device 25.

The tally restoration permission information indicates a condition relating to restoration of the confidential information S in a confidential information restoring device that is identified by device identification information corresponding to the tally restoration permission information. In other words, the tally restoration permission information 131 indicates a condition-relating to the restoration of the confidential information S in the confidential information restoring device 21. The tally restoration permission information 141 indicates a condition relating to the restoration of the confidential information S in the confidential information restoring device 22. The tally restoration permission information 151 indicates a condition relating to the restoration of the confidential information S in the confidential information restoring device 23. The tally restoration permission information 161 indicates a condition relating to the restoration of the confidential information S in the confidential information restoring device 24. The tally restoration permission information 171 indicates a condition relating to the restoration of the confidential information S in the confidential information restoring device 25.

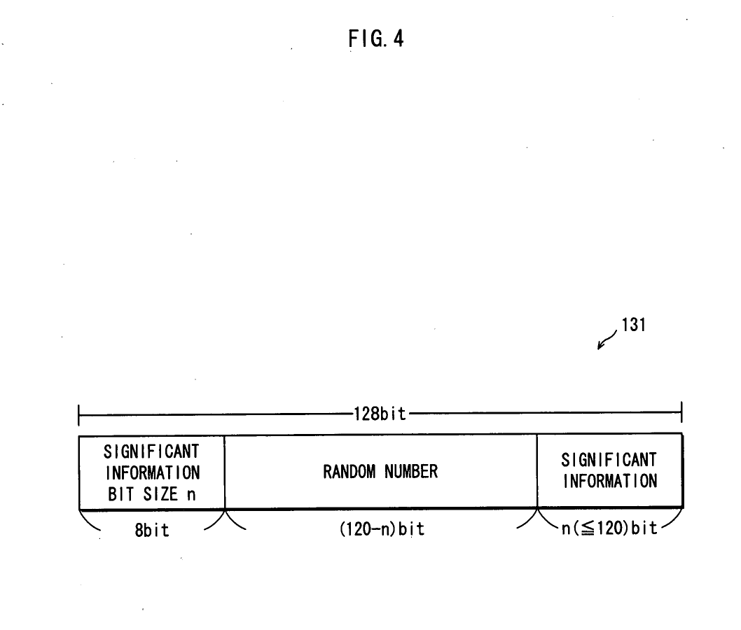

FIG. 4 is a diagram showing a data structure of the tally restoration permission information 131. As shown in FIG. 4, the tally restoration permission information 131 is 128-bit data composed of an 8-bit significant information bit size that indicates a value n (n≦120), a (120−n)-bit random number, and n-bit significant information.

The significant information bit size indicates a data length (bit size) of significant information. Only the significant information has a substantial meaning in the tally restoration permission information 131. A different value is set in the significant information according to the rule (any of the rules 1 to 4) that is set in the tally restoration permission rule information 120c.

The significant information can be obtained from the tally restoration permission information 131 by reading the significant information bit size (=n) from 8 bits at the beginning of the tally restoration permission information 131, and then extracting n bits from the end of the tally restoration permission information 131.

Note that the tally restoration permission information 141, 151, 161, and 171 have the same data structure as the tally restoration permission information 131, where a different value is set in the significant information included in the tally restoration permission information according to the rule (any of the rules 1 to 4) that is indicated by the tally restoration permission rule information 120c.

In this embodiment, hereinafter, “to set tally restoration permission information at X” means “to set significant information of tally restoration permission information at X, set the significant information bit size n at a bit size of X, and set the remaining (120−n) bits at a random number”.

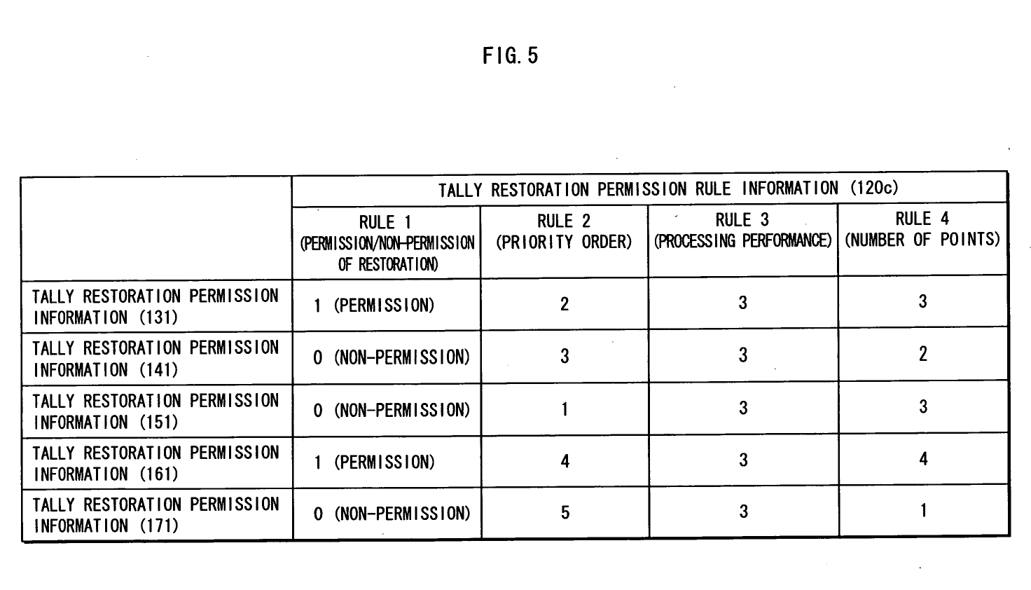

The following describes the rule indicated by the tally restoration permission rule information 120c and each of the pieces of tally restoration permission information that is set according to the rule, with reference to FIG. 5.

(a) Rule 1

When the tally restoration permission rule information 120c indicates the “rule 1”, information indicating “whether or not to permit restoration of the confidential information S” to the confidential information restoring devices 21, 22, 23, 24, and 25 is set in each of the tally restoration permission information 131, 141, 151, 161, and 171.

The following is a concrete example in this embodiment.

Tally restoration permission information 131=1 (permission)

Tally restoration permission information 141=0 (non-permission)

Tally restoration permission information 151=0 (non-permission)

Tally restoration permission information 161=1 (permission)

Tally restoration permission information 171=0 (non-permission)

Here, tally restoration permission information=1 indicates “permission”, and tally restoration permission information=0 indicates “non-permission”. In this case, the confidential information restoring devices 21 and 24 are permitted to restore the confidential information S, and the confidential information restoring devices 22, 23, and 25 are not permitted to restore the confidential information S.

(b) Rule 2

When the tally restoration permission rule information 120c indicates the “rule 2”, information indicating “a priority of restoring the confidential information S” in the confidential information restoring devices 21, 22, 23, 24, and 25 is set in each of the pieces of tally restoration permission information 131, 141, 151, 161, and 171.

The following is a concrete example in this embodiment.

Tally restoration permission information 131=2

Tally restoration permission information 141=3

Tally restoration permission information 151=1

Tally restoration permission information 161=4

Tally restoration permission information 171=5

Therefore, the following is the priority order of restoring the confidential information S in the five confidential information restoring devices, in an order of descending priorities.

Confidential information restoring device 23

Confidential information restoring device 21

Confidential information restoring device 22

Confidential information restoring device 24

Confidential information restoring device 25

Here, the priority order will be simply described.

In this embodiment, since the restoration threshold value is set at K=3, three confidential information restoring devices are involved in a restoration process of the confidential information S, and the confidential information S is restored based on three pieces of tally data. In this case, only a confidential information restoring device whose tally restoration permission information shows a highest priority of the three confidential information restoring devices is permitted to restore the confidential information S, and the other two confidential information restoring devices cannot restore the confidential information S.

(c) Rule 3

When the tally restoration permission rule information 120c indicates the “rule 3”, information indicating “processing performance of a confidential information restoring device which is permitted to restore the confidential information S” is set in each of the pieces of tally restoration permission information 131, 141, 151, 161, and 171.

Here, a calculation amount required for the restoration process of the confidential information S is determined by a value of the restoration threshold value K. More specifically, when the value of the restoration threshold value K is larger, the calculation amount of the restoration process increases. Because of this, the value of the restoration threshold value K is uniformly set in each of the pieces of tally restoration permission information in the rule 3.

The following is a concrete example in this embodiment.

Tally restoration permission information 131=3

Tally restoration permission information 141=3

Tally restoration permission information 151=3

Tally restoration permission information 161=3

Tally restoration permission information 171=3

In this case, only a confidential information restoring device that has a calculation processing capacity of restoring the confidential information S generated based on the restoration threshold value K=3 is permitted to restore the confidential information S.

Note that each of the confidential information restoring devices holds a value obtained as a result of converting a calculation processing capacity of the confidential information restoring device to the restoration threshold value K (a value indicating a maximum number of K of confidential information on which the confidential information restoring device can perform a restoration process), in advance. This will be described in detail later.

(d) Rule 4

When the tally restoration permission rule information 120c indicates the “rule 4”, information indicating “a restoration permission point” given to each of the confidential information restoring devices 21, 22, 23, 24, and 25 is set in the corresponding pieces of tally restoration permission information 131, 141, 151, 161, and 171.

The following is a concrete example in this embodiment.

Tally restoration permission information 131=3

Tally restoration permission information 141=2

Tally restoration permission information 151=3

Tally restoration permission information 161=4

Tally restoration permission information 171=1

Here, the restoration permission point is used in the restoration process of the confidential information S in the following way.

Out of the three confidential information restoring devices that are involved in the restoration process, only a confidential information restoring device, that has the highest number of points indicated by tally restoration permission information corresponding to the confidential information restoring devices, is permitted to restore the confidential information S. Also, the other two confidential information restoring devices cannot restore the confidential information S. Here, the number of points indicated by the confidential information restoration permission information is reduced by one each time the confidential information restoring device restores the confidential information S.

(2) Data Extraction Unit 102

The data extraction unit 102 analyzes the tally generation instruction information 110 received by the data input unit 101.

The data extraction unit 102 extracts each piece of data from the tally generation instruction information 110, and generates tally main data generation control information 210, tally sub data generation control information 220, and tally transmission destination information 230.

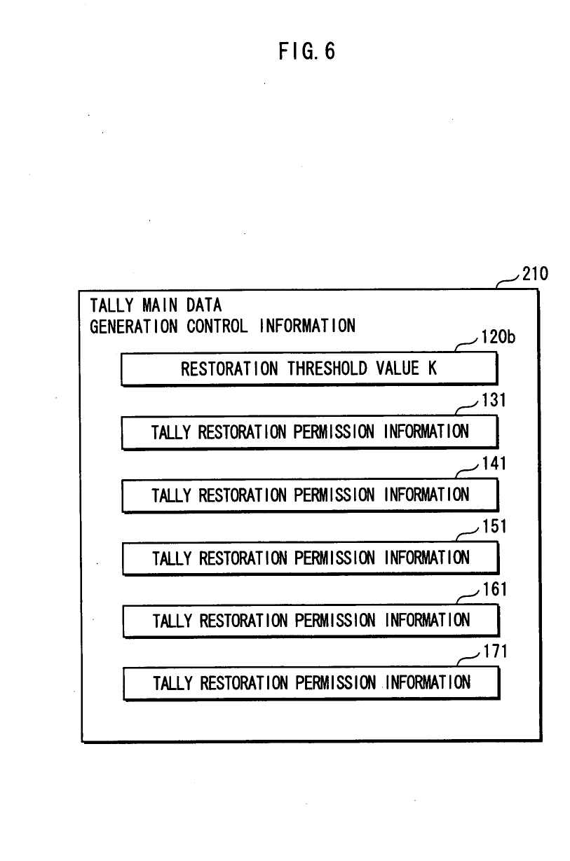

FIG. 6 is a diagram showing a data structure of the tally main data generation control information 210. As shown in FIG. 6, the tally main data generation control information 210 includes the restoration threshold value K (120b), and the pieces of tally restoration permission information 131, 141, 151, 161, and 171.

The data extraction unit 102 outputs the generated tally main data generation control information 210 to the tally main data generation unit 103.

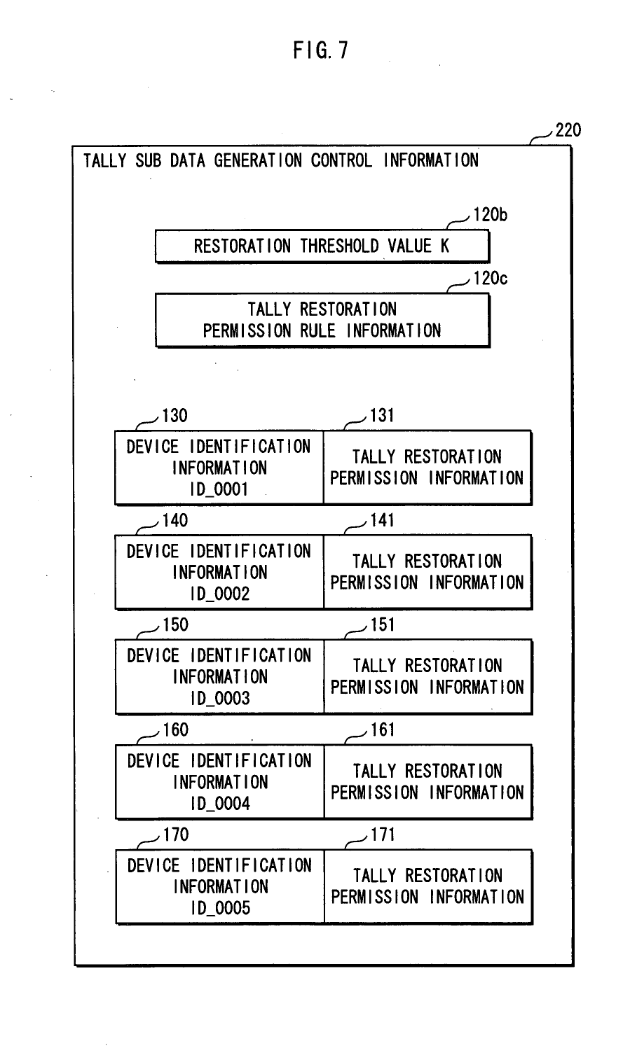

FIG. 7 is a diagram showing a data structure of the tally sub data generation control information 220. As shown in FIG. 7, the tally sub data generation control information 220 includes the restoration threshold value K (120b), the tally restoration permission rule information 120c, the device identification information ID_0001 (130) and the tally restoration permission information 131, the device identification information ID_0002 (140) and the tally restoration permission information 141, the device identification information ID_0003 (150) and the tally restoration permission information 151, the device identification information ID_0004 (160) and the tally restoration permission information 161, and the device identification information ID_0005 (170) and the tally restoration permission information 171.

The data extraction unit 102 outputs the generated tally sub data generation control information 220 to the tally data generation unit 104.

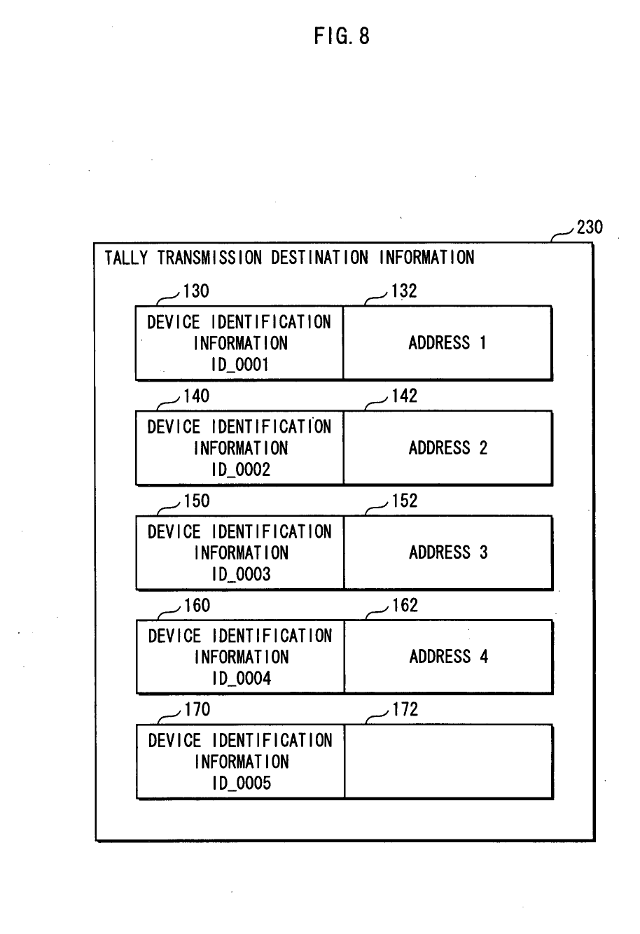

FIG. 8 is a diagram showing a data structure of the tally transmission destination information 230. As shown in FIG. 8, the tally transmission destination information 230 associates device identification information of a confidential information restoring device which is a transmission destination of tally data, with an address of the confidential information restoring device. More specifically, the tally transmission destination information 230 includes the device identification information ID_0001 (130) and an address 1 (132), the device identification information ID_0002 (140) and an address 2 (142), the device identification information ID_0003 (150) and an address 3 (152), the device identification information ID_0004 (160) and an address 4 (162), and the device identification information ID_0005 (170).

Here, the data extraction unit 102 holds a list of the device identification information and the transmission destination information in correspondence with each other for each of the plurality of confidential information restoring devices, in advance. The transmission destination information is a network address required for transmitting data from the tally generating device 10 to each of the confidential information restoring devices via the network 30, such as an IP address or the like.

The data extraction unit 102 extracts, from the list, the address 1 (132), the address 2 (142), the address 3 (152), and the address 4 (162) that are the transmission destination information respectively corresponding to the device identification information ID_0001 (130), the device identification information ID_0002 (140), the device identification information ID_0003 (150), and the device identification information ID_0004 (160) that are extracted from the tally generation instruction information 110.

Note that in the tally transmission destination information 230, a field of the transmission destination information corresponding to the device identification information ID_0005 (170) is blank. This indicates that the tally generating device 10 does not transmit the tally data via the network 30, but transfers the tally data to a memory card (i.e. the confidential information restoring device 25) which is inserted in the tally generating device 10.

The data extraction unit 102 outputs the generated tally transmission destination information 230 to the tally data transmission unit 105.

(3) Tally Main Data Generation Unit 103

The tally main data generation unit 103 generates tally main data Yᵢ based on the confidential information S which is received from the data input unit 101 and the tally main data generation control information 210 which is received from the data extraction unit 102.

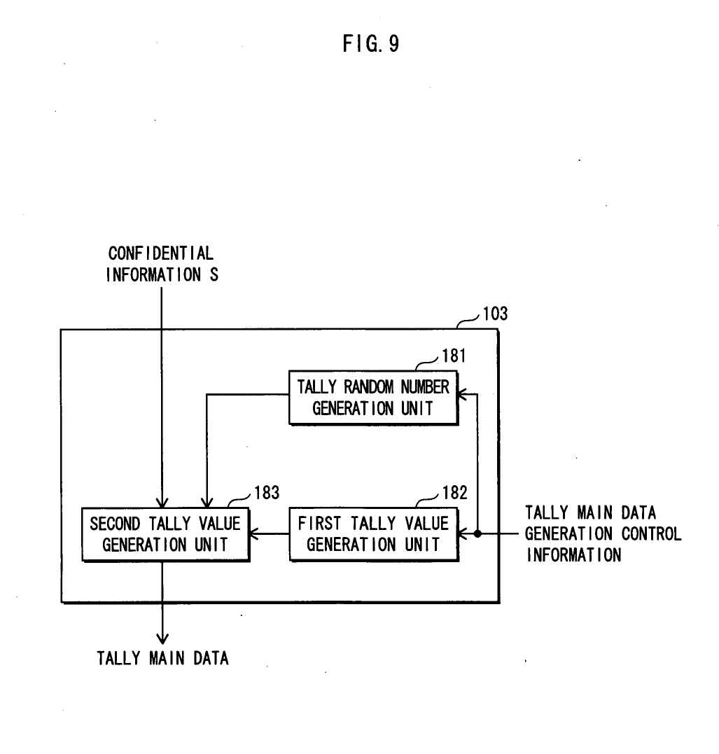

FIG. 9 is a functional block diagram showing a functional structure of the tally main data generation unit 103. As shown in FIG. 9, the tally main data generation unit 103 includes a tally random number generation unit 181, a first tally value generation unit 182, and a second tally value generation unit 183.

The confidential information S is inputted to the second tally value generation unit 183. Also, in the tally main data generation control information 210, the restoration-threshold value K (120b) is inputted to the tally random number generation unit 181, and the tally restoration permission information 131, 141, 151, 161, and 171 are inputted to the first tally value generation unit 182.

The tally random number generation unit 181 generates random numbers for generating a tally, based on the restoration threshold value K (120b). More specifically, the tally random number generation unit 181 reads the value of the restoration threshold value K, and generates K (=3) 1-byte random numbers R₁, R₂, and R₃. The tally random number generation unit 181 outputs the generated random numbers R₁, R₂, and R₃ to the second tally value generation unit 183.

The first tally value generation unit 182 generates a first tally value Xᵢ (i=1, 2, . . . , 5) based on the pieces of tally restoration permission information 131, 141, 151, 161, and 171. More specifically, the first tally value generation unit 182 calculates a hash value of each of C₁=Tally restoration permission information 131, C₂=Tally restoration permission information 141, C₃=Tally restoration permission information 151, C₄=Tally restoration permission information 161, and C₅=Tally restoration permission information 171, using a one-way hash function Hash, in order to generate five first tally values X₁=Hash (C₁), X₂=Hash (C₂), X₃=Hash (C₃), X₄=Hash, (C₄) X₅=Hash (C₅).

Here, Hash (x) indicates a 1-byte hash value that is calculated for an input x using the hash function Hash.

The first tally value generation unit 182 outputs the generated first tally values X₁, X₂, X₃, X₄, and X₅ to the second tally value generation unit 183.

The second tally value generation unit 183 generates tally main data Yᵢ from the confidential information S, the random numbers R₁, R₂, and R₃, and the first tally values X₁, X₂, X₃, X₄, and X₅.

Firstly, the second tally value generation unit 183 divides the L-byte confidential information S into byte units, i.e. S [1], S [2], . . . , S [L] from the beginning top of the confidential information S.

Next, the second tally value generation unit 183 obtains second tally values Y₁ [m], Y₂ [m], . . . , Y₅ [m] using the following (formula 1), for i=1, 2, . . . , 5, and m=1, 2, . . . , L.

$${Y}_{i} [ m ] = S [ m ] + {\sum }_{j = 1}^{K} {R}_{j} ⨯ {X}_{i}^{j} \qquad ( formula 1 )$$

Here, all operations in the (formula 1) such as addition, multiplication, and exponentiation are performed on a finite field GF (2ˆ8) (2ˆ8 indicates 2 to the 8^{th} power).

The second tally value generation unit 183 outputs the second tally values Y₁ [m], Y₂ [m], . . . , Y₅ [m] (m=1, 2, . . . , L) that are calculated as mentioned above, to the tally data generation unit 104 as the tally main data.

Note that in this embodiment, each piece of tally main data is also referred to as Y₁, Y₂, Y₃, Y₄, and Y₅ as follows.

Tally main data Y₁=Y₁ [m]=Y₁ [1], Y₁ [2], . . . , Y₁ [L]

Tally main data Y₂=Y₂ [m]=Y₂ [1], Y₂ [2], . . . , Y₂ [L]

Tally main data Y₃=Y₃ [m]=Y₃ [1], Y₃ [2], . . . , Y₃ [L]

Tally main data Y₄=Y₄ [m]=Y₄ [1], Y₄ [2], . . . , Y₄ [L]

Tally main data Y₅=Y₅ [m]=Y₅ [1], Y₅ [2], . . . , Y₅ [L]

(4) Tally Data Generation Unit 104

The tally data generation unit 104 receives the pieces of tally main data Y₁, Y₂, Y₃, Y₄, and Y₅ from the tally main data generation unit 103.

Also, the tally data generation unit 104 receives the tally sub data generation control information 220 shown in FIG. 7 from the data extraction unit 102, and generates five pieces of tally sub data F₁, F₂, F₃, F₄, and F₅ from the tally sub data generation control information 220.

The five pieces of tally sub data are in one-to-one correspondence with the confidential information restoring devices, and are each information for controlling the restoration process of the confidential information S in the corresponding confidential information restoring device.

The tally sub data F₁ corresponds to the confidential information restoring device 21, and includes the restoration threshold value K (120b), the tally restoration permission rule information 120c, the device identification information ID_0001 (130), and the tally restoration permission information 131.

The tally sub data F₂ corresponds to the confidential information restoring device 22, and includes the restoration threshold value K (120b), the tally restoration permission rule information 120c, the device identification information ID_0002 (140), and the tally restoration permission information 141.

The tally sub data F₃ corresponds to the confidential information restoring device 23, and includes the restoration threshold value K (120b), the tally restoration permission rule information 120c, the device identification information ID_0003 (150), and the tally restoration permission information 151.

The tally sub data F₄ corresponds to the confidential information restoring device 24, and includes the restoration threshold value K (120b), the tally restoration permission rule information 120c, the device identification information ID_0004 (160), and the tally restoration permission information 161.

The tally sub data F₅ corresponds to the confidential information restoring device 25, and includes the restoration threshold value K (120b), the tally restoration permission rule information 120c, the device identification information ID_0005 (170), and the tally restoration permission information 171.

The tally data generation unit 104 pairs the tally main data Y₁ with the tally sub data F₁ to make tally data W₁, pairs the tally main data Y₂ with the tally sub data F₂ to make tally data W₂, pairs the tally main data Y₃ with the tally sub data F₃ to make tally data W₃, pairs the tally main data Y₄ with the tally sub data F₄ to make tally data W₄, and pairs the tally main data Y₅ with the tally sub data F₅ to make tally data W₅.

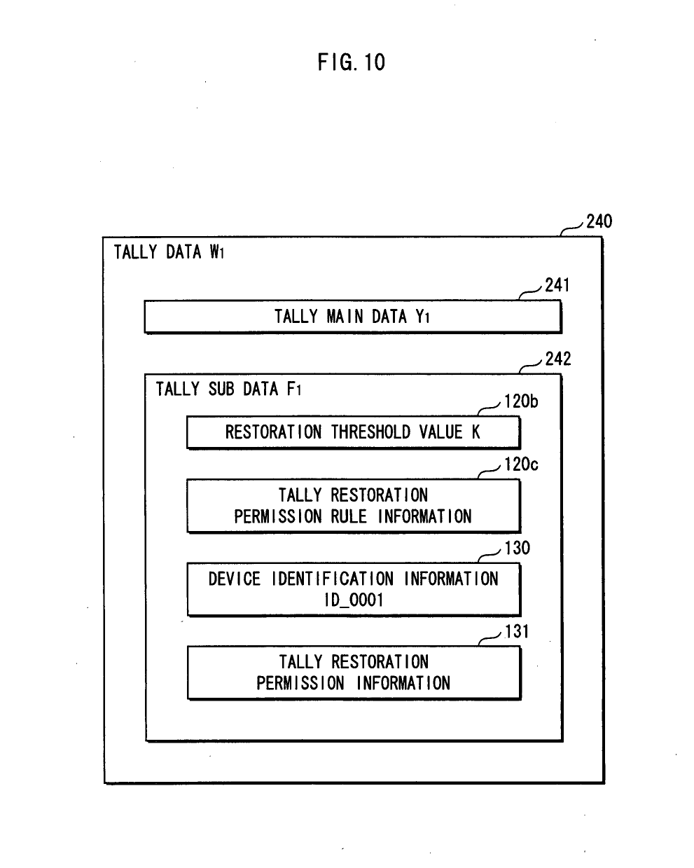

FIG. 10 is a diagram showing a data structure of the tally data W₁ (240). As shown in FIG. 10, the tally data W₁ (240) is composed of the tally main data Y₁ (241) and the tally sub data F₁ (242).

The tally data generation unit 104 outputs the pieces of tally data W₁, W₂, W₃, W₄, and W₅ to the tally data transmission unit 105.

(5) Tally Data Transmission Unit 105

The tally data transmission unit 105 is composed of a network connection unit and a memory card input/output unit.

The tally data transmission unit 105 receives the tally transmission destination information 230 shown in FIG. 8, from the data extraction unit 102. Also, the tally data transmission unit 105 receives the pieces of tally data W₁, W₂, W₃, W₄, and W₅ from the tally data generation unit 104.

The tally data transmission unit 105 judges the device identification information included in each of the pieces of tally data to obtain a corresponding address from the tally transmission destination information 230. The tally data transmission unit 105 transmits each of the pieces of tally data to the obtained address as a transmission destination, via the network 30.

Here, the tally data transmission unit 105 cannot obtain an address corresponding to the device identification information ID_0005 (170) from the tally transmission destination information 230. When the address cannot be obtained, the tally data transmission unit 105 judges that the confidential information restoring device 25 that is identified by the device identification information ID_0005 (170) is a memory card. In this case, the tally data transmission unit 105 transfers the tally data W₅ to the confidential information restoring device 25 in a state in which the confidential information restoring device 25 is inserted in a memory card slot.

### Operation of Tally Generation Process

(1) Whole Operation

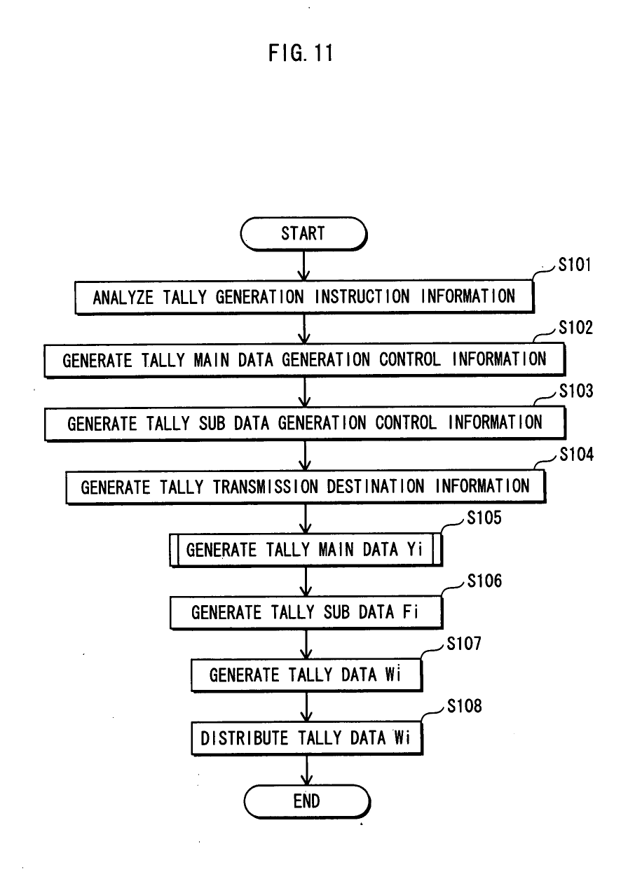

The following describes an operation of a tally generation process by the tally generating device 10, with reference to a flowchart shown in FIG. 11.

The tally generation process starts when the data input unit 101 receives inputs of the confidential information S and the tally generation instruction information 110. The data input unit 101 outputs the confidential information S to the tally main data generation unit 103, and outputs the tally generation instruction information 110 to the data extraction unit 102.

The data extraction unit 102 analyzes the tally generation instruction information 110 (step S101). Then, the data extraction unit 102 generates the tally main data generation control information 210 shown in FIG. 6 (step S102), and further generates the tally sub data generation control information 220 shown in FIG. 7 (step S103).

The data extraction unit 102 outputs the tally main data generation control information 210 to the tally main data generation unit 103, and outputs the tally sub data generation control information 220 to the tally data generation unit 104.

Also, the data extraction unit 102 generates the tally transmission destination information 230 shown in FIG. 8, based on the list of the device identification information and the transmission destination information in correspondence with each other (step S104). Note that the data extraction unit 102 holds the list in advance.

The data extraction unit 102 outputs the tally transmission destination information 230 to the tally data transmission unit 105.

Next, the tally main data generation unit 103 generates the tally main data Y₁ based on the confidential information S and the tally main data generation control information 210 (step S105). Here, i=1, 2, . . . , 5. A detailed operation of generating the tally main data Y₁ will be described later.

The tally main data generation unit 103 outputs the generated tally main data Y₁ to the tally data generation unit 104.

The tally data generation unit 104 generates the tally sub data Fᵢ corresponding to each of the confidential information restoring devices based on the tally sub data generation control information 220 (step S106).

Then, the tally data generation unit 104 associates the tally main data Y₁ generated in step S105 with the tally sub data Fᵢ generated in step S106 to generate the tally data Wᵢ (step S107). The tally data generation unit 104 outputs the generated the tally data Wᵢ to the tally data transmission unit 105.

The tally data transmission unit 105 distributes the tally data Wᵢ received from the tally data generation unit 104 to each of the confidential information restoring devices (step S108).

More specifically, the tally data transmission unit 105 transmits the tally data W₁ to the confidential information restoring device 21 via the network 30, transmits the tally data W₂ to the confidential information restoring device 22, transmits the tally data W₃ to the confidential information restoring device 23, and transmits the tally data W₄ to the confidential information restoring device 24. Also, the tally data transmission unit 105 transfers the tally data W₅ to the confidential information restoring device 25 which is inserted in the memory card slot of the tally generating device 10.

(2) Operation of Tally Main Data Generation Process

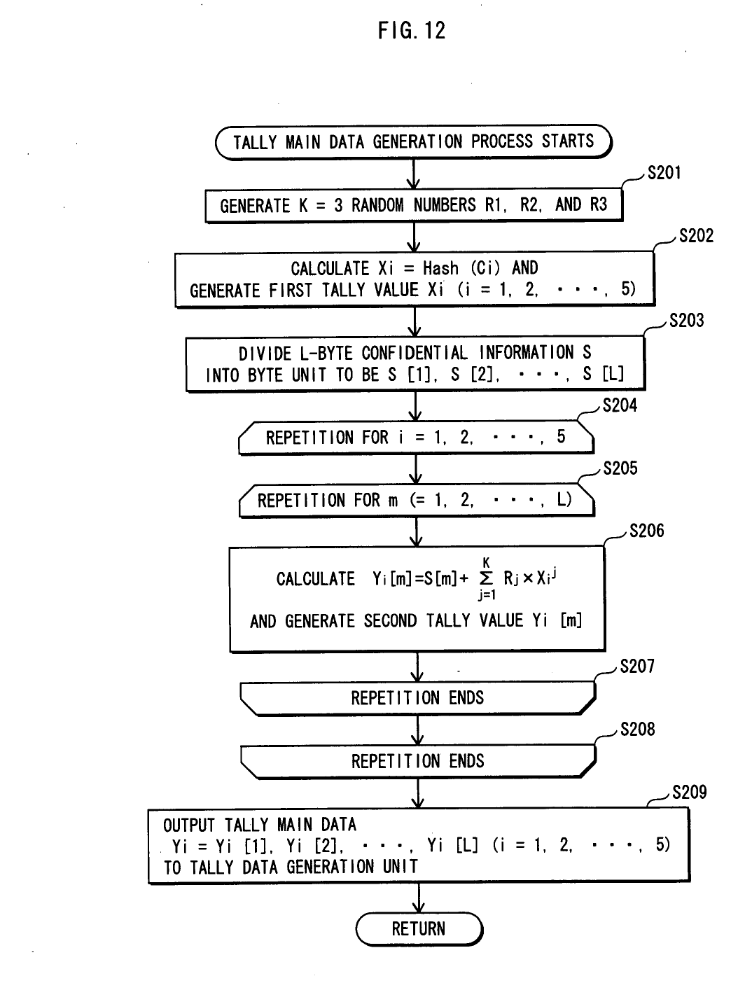

The following describes an operation of a tally main data generation process, with reference to a flowchart shown in FIG. 12. Note that the operation shown in FIG. 12 is a detail of step S105 in FIG. 11.

The tally random number generation unit 181 in the tally main data generation unit 103 generates three 1-byte random numbers R₁, R₂, and R₃ which are the same number as the restoration threshold value K (step S201).

Next, the first tally value generation unit 182 calculates Xᵢ=Hash (Cᵢ) to generate the first tally value Xᵢ (i=1, 2, . . . , 5), in the following case of each of the pieces of tally restoration permission information that is 128-bit data (step S202).

C₁=Tally restoration permission information 131

C₂=Tally restoration permission information 141

C₃=Tally restoration permission information 151

C₄=Tally restoration permission information 161

C₅=Tally restoration permission information 171

Then, the second tally value generation unit 183 divides the L-byte confidential information S into byte units, i.e. S [1], S [2], . . . , S [L] (step S203).

The second tally value generation unit 183 repeats processes from steps S205 to S207, for i=1, 2, . . . , 5 (steps S204 and S208).

The second tally value generation unit 183 repeats the process of step S206, for m=1, 2, . . . , L (steps S205 and S207).

The second tally value generation unit 183 calculates Yᵢ

$$[ m ] = S [ m ] + {\sum }_{j = 1}^{K} {R}_{j} ⨯ {X}_{i}^{j}$$

to generate the second tally value Y₁ [m] (step S206).

The second tally value generation unit 183 outputs the tally main data Yᵢ to the tally data generation unit 104 (step S209).

Here, the following are the tally main data Yᵢ.

Y₁=Y₁ [m]=Y₁ [1], Y₁ [2], . . . , Y₁ [L]

Y₂=Y₂ [m]=Y₂ [1], Y₂ [2], . . . , Y₂ [L]

Y₃=Y₃ [m]=Y₃ [1], Y₃ [2], . . . , Y₃ [L]

Y₄=Y₄ [m]=Y₄ [1], Y₄ [2], . . . , Y₄ [L]

Y₅=Y₅ [m]=Y₅ [1], Y₅ [2], . . . , Y₅ [L]

Structure of Confidential Information Restoring Device 21

Here, a structure of the confidential information restoring device 21 will be described.

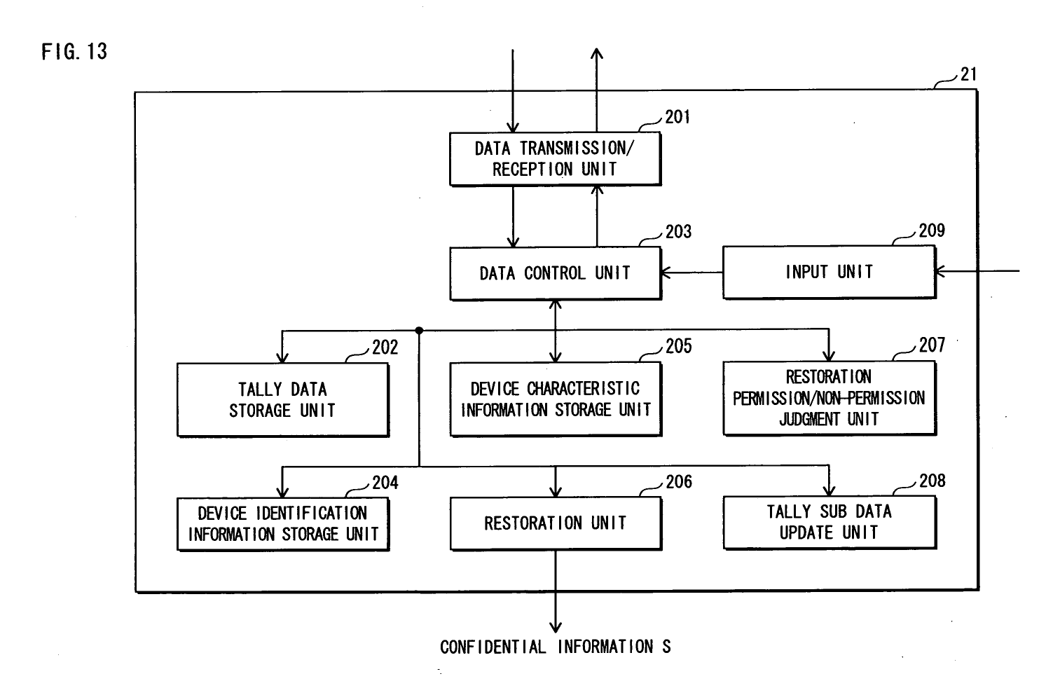

FIG. 13 is a functional block diagram functionally showing the structure of the confidential information restoring device 21. As shown in FIG. 13, the confidential information restoring device 21 includes a data transmission/reception unit 201, a tally data storage unit 202, a data control unit 203, a device identification information storage unit 204, a device characteristic information storage unit 205, a restoration unit 206, a restoration permission/non-permission judgment unit 207, a tally sub data update unit 208, and an input unit 209.

More specifically, the confidential information restoring device 21 is a computer system that is composed of a microprocessor, a ROM, a RAM, a hard disk unit, a network connection unit, or the like. The confidential information restoring device 21 fulfills a function thereof because the microprocessor operates according to a computer program.

Note that the confidential information restoring devices 22, 23, and 24 have the same structure as the confidential information restoring device 21. Because the confidential information restoring device 25 is a memory card, the confidential information restoring device 25 includes component parts corresponding to the tally data storage unit 202, the device identification information storage unit 204, and the device characteristic information storage unit 205 in the confidential information restoring device 21. The confidential information restoring device 25 is used by being inserted in a memory card slot of other devices.

This embodiment is described assuming that the restoration threshold value K=3. Therefore, this embodiment will be described assuming that three confidential information restoring devices composed of the confidential information restoring devices 21, 22, and 23 out of the five confidential information restoring devices are involved in the restoration process of the confidential information S. However, this is one concrete example, and any combination of optional three confidential information restoring devices out of the five confidential information restoring devices may be used.

(1) Data Transmission/Reception Unit 201

The data transmission/reception unit 201 is a network connection unit and performs transmission/reception of data between the data control unit 203 and the tally generating device 10, and between the data control unit 203 and other confidential information restoring device via the network 30.

More specifically, the data transmission/reception unit 201 receives the tally data W₁ from the tally generating device 10.

Also, the data transmission/reception unit 201 transmits the tally data W₁ to the confidential information restoring devices 22 and 23, receives the tally data W₂ from the confidential information restoring device 22, and receives the tally data W₃ from the confidential information restoring device 23.

(2) Tally Data Storage Unit 202

The tally data storage unit 202 stores the tally data W₁ received from the tally generating device 10.

Also, the tally data storage unit 202 temporarily stores the tally data W₂ received from the confidential information restoring device 22 and the tally data W₃ received from the confidential information restoring device 23, while the restoration unit 206 and the restoration permission/non-permission judgment unit 207 perform a confidential information restoring process.

(3) Data Control Unit 203

When obtaining the tally data W₁ from the tally generating device 10 via the data transmission/reception unit 201, the data control unit 203 judges whether device identification information included in the tally sub data F₁ in the tally data W₁ is identical to device identification information stored in the device identification information storage unit 204. When both pieces of device identification information are identical to each other, the data control unit 203 writes the obtained tally data W₁ to the tally data storage unit 202. When both pieces of device identification information are not identical to each other, the data control unit 203 discards the obtained tally data W₁.

Also, when receiving a confidential information restoration request from the input unit 209, the data control unit 203 requests the tally data W₂ and the tally data W₃ to the confidential information restoring devices 22 and 23 via the data transmission/reception unit 201. Note that network addresses of the other confidential information restoring devices may be stored in the data control unit 203 or the data transmission/reception unit 201.

Moreover, when receiving information indicating “Restoration is not permitted” from the restoration permission/non-permission judgment unit 207 in a restoration permission/non-permission judgment process of the confidential information S, the data control unit 203 reads the tally data W₂ and tally data W₃ that are temporarily stored in the tally data storage unit 202, and discards the tally data W₂ and tally data W₃.

Furthermore, the data control unit 203 controls input/output of data for each unit in the confidential information restoring device 21. Note that in this embodiment, each unit in the confidential information restoring device 21 inputs and outputs data via the data control unit 203 even if the input/output of data is not especially described.

(4) Device Identification Information Storage Unit 204

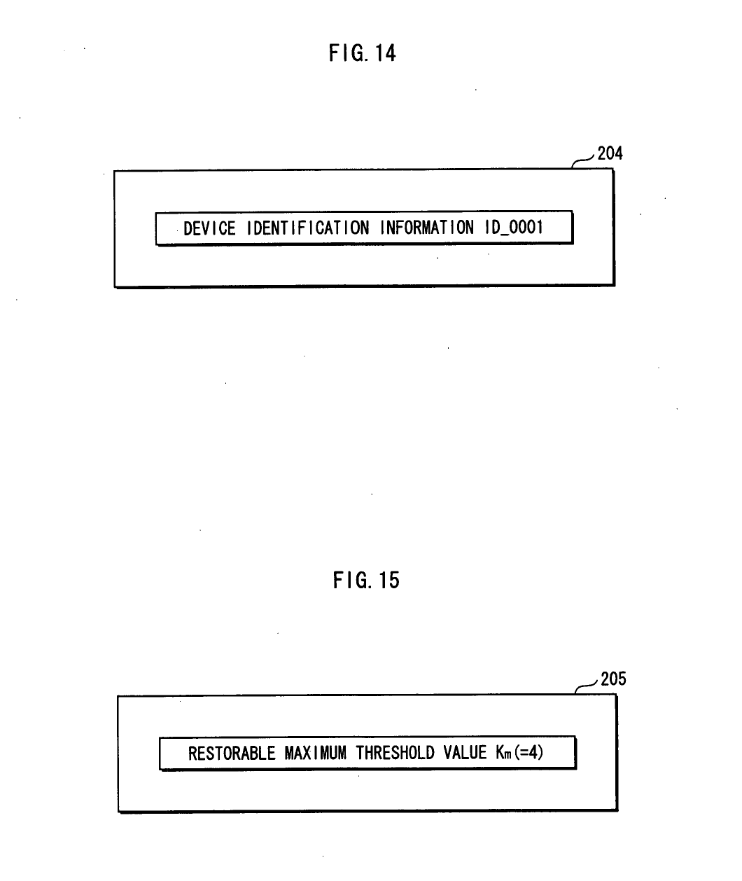

The device identification information storage unit 204 stores the device identification information ID_0001 which is an identifier of the confidential information restoring device 21 as shown in FIG. 14.

(5) Device Characteristic Information Storage Unit 205

The device characteristic information storage unit 205 stores information indicating a device characteristic of the confidential information restoring device 21.

In this embodiment, the device characteristic information storage unit 205 stores a restorable maximum threshold value Kₘ as a concrete example. The restorable maximum threshold value Kₘ is a value obtained by converting processing performance of a confidential information restoring device to a restoration threshold value.

In other words, the restorable maximum threshold value Kₘ of the confidential information restoring device 21 is Kₘ=4. Therefore, it means that the confidential information restoring device 21 has processing performance that can restore confidential information whose restoration threshold value K is equal to or smaller than 4.

(6) Restoration Unit 206

When receiving information indicating “Restoration is permitted” from the restoration permission/non-permission judgment unit 207, the restoration unit 206 performs a restoration process of the confidential information S using the pieces of tally data W₁, W₂, and W₃ that are stored in the tally, data storage unit 202 as follows.

Firstly, the restoration unit 206 extracts the pieces of tally sub data F₁, F₂, and F₃ from the pieces of tally data W₁, W₂, and W₃. Also, the restoration unit 206 extracts the pieces of tally restoration permission information 131, 141, and 151 that are included in the pieces of tally sub data F₁, F₂, and F₃ respectively.

Here, if C₁=Tally restoration permission information 131, C₂=Tally restoration permission information 141, and C₃=Tally restoration permission information 151, the restoration unit 206 calculates a one-way hash function Hash for each of C₁, C₂, and C₃ to generate three first tally values X₁=Hash (C₁), X₂=Hash (C₂), and X₃ Hash (C₃).

Then, the restoration unit 206 calculates byte confidential information S [1], S [2], . . . , S [L] from the tally first values X₁, X₂, and X₃, and the pieces of tally main data Y₁=Y₁ [1], Y₁ [2], . . . , Y₁ [L], Y₂=Y₂ [1], Y₂ [2], . . . , Y₂ [L], and Y₃=Y₃ [1], Y₃ [2], . . . , Y₃ [L] that are included in the pieces of tally data W₁, W₂, and W₃.

Here, the byte confidential information is a value obtained by dividing the confidential information S for one byte, and is calculated using the following (formula 2) and (formula 3). Note that all of addition, subtraction, multiplication, and division operations are performed on a finite field GF (2ˆ8)

$$\begin{matrix}S [ m ] = {\sum }_{i = 1}^{K} Pi [ m ] & ( formula 2 ) \\ {P}_{i} [ m ] = {Y}_{i} [ m ] {\prod }_{{j = 1}_{j \neq i}}^{K} \frac{Xj}{Xj - Xi} & ( formula 3 )\end{matrix}$$

The restoration unit 206 connects the generated byte confidential information S [1], S [2], . . . , S [L] with each other to generate the confidential information S. The restoration unit 206 outputs the generated confidential information S.

(7) Restoration Permission/Non-Permission Judgment Unit 207

The restoration permission/non-permission judgment unit 207 performs the restoration permission/non-permission judgment process of the confidential information S, using the pieces of tally sub data F₁, F₂, and F₃ that are stored in the tally data storage unit 202 and the restorable maximum threshold value Kₘ that is stored in the device characteristic information storage unit 205.

The restoration permission/non-permission judgment process is different in accordance with a rule indicated by the tally restoration permission rule information 120c included in the tally sub data F₁.

When the tally restoration permission rule information 120c indicates the “rule 1”, the restoration permission/non-permission judgment unit 207 performs the restoration permission/non-permission judgment process using the tally restoration permission information 131 included in the tally sub data F₁.

When the tally restoration permission rule information 120c indicates the “rule 2” or the “rule 4”, the restoration permission/non-permission judgment unit 207 performs the restoration permission/non-permission judgment process using the tally restoration permission information 131 included in the tally sub data F₁, the tally restoration permission information 141 included in the tally sub data F₂, and the tally restoration permission information 151 included in the tally sub data F₃.

When the tally restoration permission rule information 120c indicates the “rule 3”, the restoration permission/non-permission judgment unit 207 performs the restoration permission/non-permission judgment process using the tally restoration permission information 131 included in the tally sub data F₁ and the restorable maximum threshold value Kₘ.

As a result of the restoration permission/non-permission judgment process, when judging that “Restoration is permitted”, the restoration permission/non-permission judgment unit 207 outputs information indicating “Restoration is permitted” to the restoration unit 206 via the data control unit 203, and when judging that “Restoration is not permitted”, the restoration permission/non-permission judgment unit 207 outputs information indicating “Restoration is not permitted” to the data control unit 203.

(8) Tally Sub Data Update Unit 208

When the tally restoration permission rule information 120c indicates the “rule 4” and the restoration process of the confidential information S is performed in the restoration unit 206, the tally sub data update unit 208 subtracts 1 from a restoration permission point that is set in the tally restoration permission information 131 and updates the number of points.

(9) Input Unit 209

The input unit 209 includes an input device for receiving an instruction from a user, and receives a confidential information restoration request from the user. The input unit 209 outputs the received confidential information restoration request to the data control unit 203.

Operation of Confidential Information Restoration Process

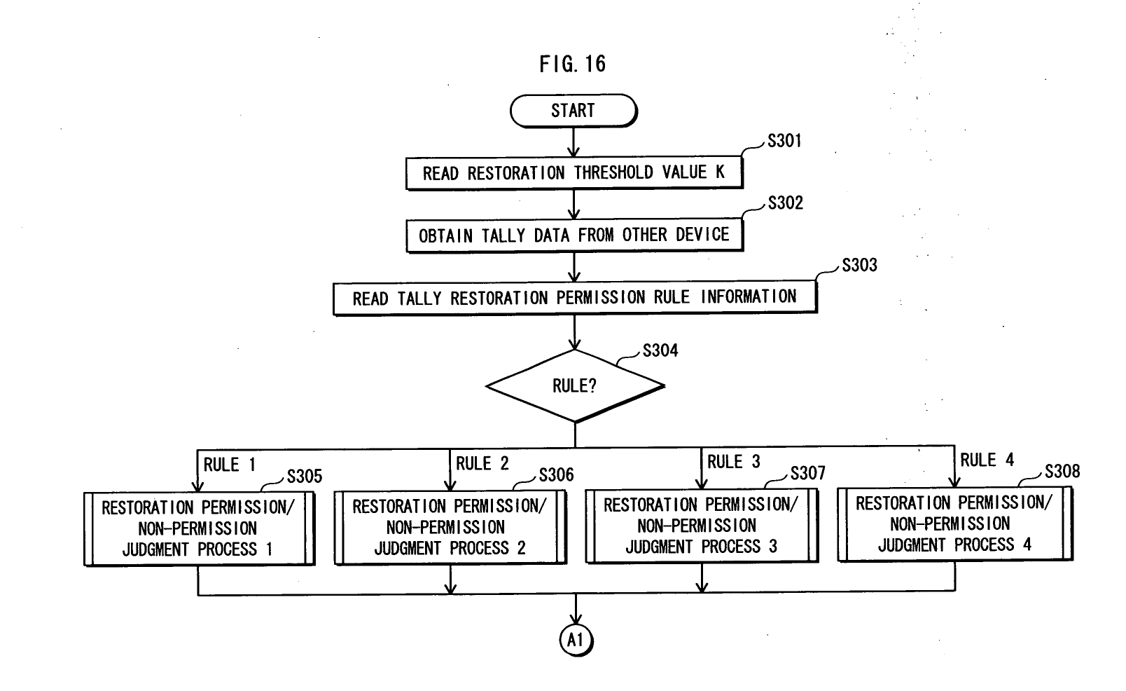

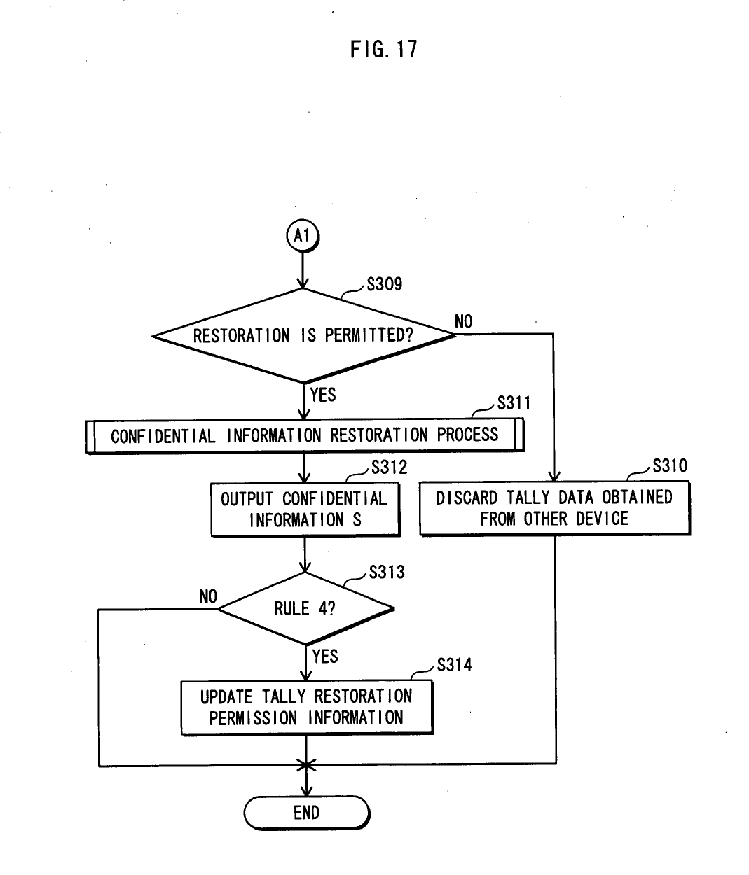

The following describes an operation of the confidential information restoration process, with reference to flowcharts shown in FIGS. 16 and 17. Note that a confidential information restoration process by the confidential information restoring device 21 will be described as a concrete example here. However, other devices in which the confidential information restoring devices 22, 23, 24, and 25 are inserted can operate in the same way as the operation that will be described here.

(1) Whole Operation

The confidential information restoration process starts when the input unit 209 receives a confidential information restoration request.

Firstly, the data control unit 203 reads the restoration threshold value K (120b) from the tally sub data F₁ included in the tally data W₁ that is stored in the tally data storage unit 202 (step S301).

Because K=3 in this embodiment, the restoration of the confidential information S requires three pieces of tally data including the tally data W₁ that is held in the confidential information restoring device 21. Therefore, the data control unit 203 obtains the pieces of tally data from other two confidential information restoring devices via the data transmission/reception unit 201 (step S302). More specifically, the data control unit 203 obtains the tally data W₂ from the confidential information restoring device 22, and obtains the tally data W₃ from the confidential information restoring device 23.

The data control unit 203 writes the obtained pieces of tally data W₂ and W₃ to the tally data storage unit 202.

Next, the restoration permission/non-permission judgment unit 207 reads the tally restoration permission rule information 120c from the tally sub data F₁ (step S303), and judges which rule is set in the tally restoration permission rule information 120c.

When the rule 1 is set in the tally restoration permission rule information 120c (“rule 1” in step S304), the restoration permission/non-permission judgment unit 207 performs a restoration permission/non-permission judgment process 1 (step S305).

When the rule 2 is set in the tally restoration permission rule information 120c (“rule 2” in step S304), the restoration permission/non-permission judgment unit 207 performs a restoration permission/non-permission judgment process 2 (step S306).

When the rule 3 is set in the tally restoration permission rule information 120c (“rule 3” in step S304), the restoration permission/non-permission judgment unit 207 performs a restoration permission/non-permission judgment process 3 (step S307).

When the rule 4 is set in the tally restoration permission rule information 120c (“rule 4” in step S304), the restoration permission/non-permission judgment unit 207 performs a restoration permission/non-permission judgment process 4 (step S308).

The data control unit 203 judges whether information received from the restoration permission/non-permission judgment unit 207 indicates “Restoration is permitted” or “Restoration is not permitted”.

When the information indicates “Restoration is not permitted” (“NO” in step S309), the data control unit 203 reads the pieces of tally data W₂ and W₃ that are stored in the tally data storage unit 202 and discards the pieces of tally data W₂ and W₃ (step S310).

When the information indicates “Restoration is permitted” (“YES” in step S309), the data control unit 203 outputs the information indicating “Restoration is permitted” to the restoration unit 206. After that, the restoration unit 206 performs the confidential information restoration process to generate the confidential information S (step S311). The restoration unit 206 outputs the generated confidential information S (step S312).

Then, the data control unit 203 reads the tally restoration permission rule information 120c from the tally sub data F₁, and judges whether the tally restoration permission rule information 120c indicates the rule 4.

When the tally restoration permission rule information 120c indicates the rules other than the rule 4 (“NO” in step S313), the confidential information restoration process ends.

When the tally restoration permission rule information 120c indicates the rule 4 (“YES” in step S313), the data control unit 203 outputs an update instruction to the tally sub data update unit 208.

When receiving the update instruction of the tally restoration permission information 131 from the data control unit 203, the tally sub data update unit 208 reads the tally sub data F₁ from the tally data storage unit 202, and updates the number of points indicated by the tally restoration permission information 131 included in the tally sub data F₁ by subtracting 1 from the number of points (step S314).

(2) Operation of Restoration Permission/Non-Permission Judgment Process 1

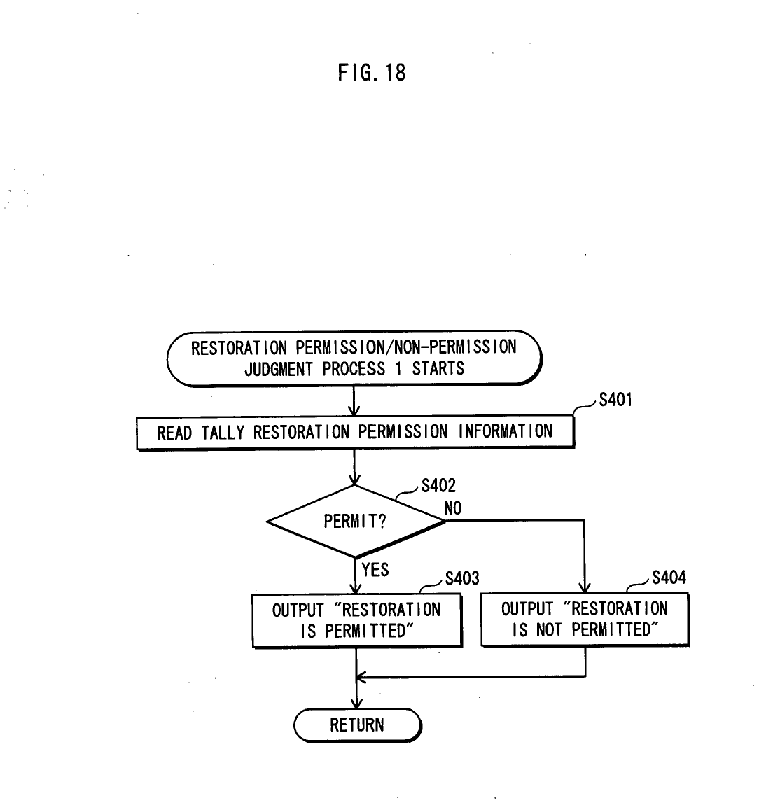

The following describes an operation of the restoration permission/non-permission judgment process 1, with reference to a flowchart shown in FIG. 18. Note that the operation described here is a detail of step S305 in FIG. 16.

The restoration permission/non-permission judgment unit 207 reads the tally restoration permission information 131 included in the tally sub data F₁ (step S401), and judges which one of “1 (permission)” and “0 (non-permission)” is the read tally restoration permission information 131 set at.

When the tally restoration permission information 131 is set at “1 (permission)” (“YES” in step S402), the restoration permission/non-permission judgment unit 207 outputs the information indicating “Restoration is permitted” to the data control unit 203 (step S403).

When the tally restoration permission information 131 is set at “0 (non-permission)” (“NO” in step S402), the restoration permission/non-permission judgment unit 207 outputs the information indicating “Restoration is not permitted” to the data control unit 203 (step S404).

Note that in the example shown in FIG. 5, the tally restoration permission information 131 is set at “1 (permission)”. Therefore, the restoration permission/non-permission judgment unit 207 outputs the information indicating “Restoration is permitted” to the data control unit 203 in this example.

(3) Operation of Restoration Permission/Non-Permission Judgment Process 2

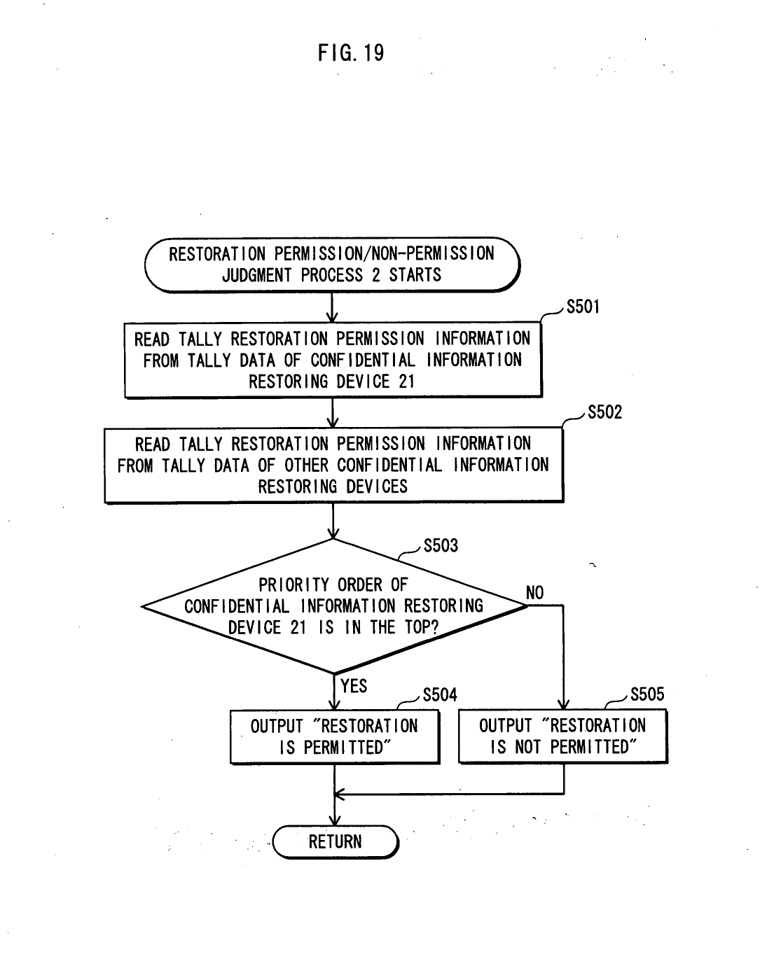

The following describes an operation of the restoration permission/non-permission judgment process 2, with reference to a flowchart shown in FIG. 19. Note that the operation described here is a detail of step S306 in FIG. 16.

The restoration permission/non-permission judgment unit 207 reads the tally restoration permission information 131 from the tally sub data F₁ included in the tally data W₁ of the confidential information restoring device 21 (step S501).

Then, the restoration permission/non-permission judgment unit 207 reads the pieces of tally restoration permission information 141 and 151 from the pieces of tally sub data F₂ and F₃ included in the pieces of tally data W₂ and W₃ Of the other confidential information restoring devices (step S502).

The restoration permission/non-permission judgment unit 207 compares priority orders that are set in the pieces of tally restoration permission information 131, 141, and 151, and judges whether a priority order of the confidential information restoring device 21 is in the top.

When the priority order of the confidential information restoring device 21 is in the top (“YES” in step S503), the restoration permission/non-permission judgment unit 207 outputs the information indicating “Restoration is permitted” to the data control unit 203 (step S504).

When the priority order of the confidential information restoring device 21 is not in the top (“NO” in step S503), the restoration permission/non-permission judgment unit 207 outputs the information indicating “Restoration is not permitted” to the data control unit 203 (step S505).

Note that in the example shown in FIG. 5, the tally restoration permission information 131 is set at “2”, the tally restoration permission information 141 is set at “3”, and the tally restoration permission information 151 is set at “1. Therefore, the restoration permission/non-permission judgment unit 207 outputs the information indicating “Restoration is not permitted” to the data control unit 203 because the priority order of the confidential information restoring device 21 is not in the top in this example.

(4) Operation of Restoration Permission/Non-Permission Judgment Process 3

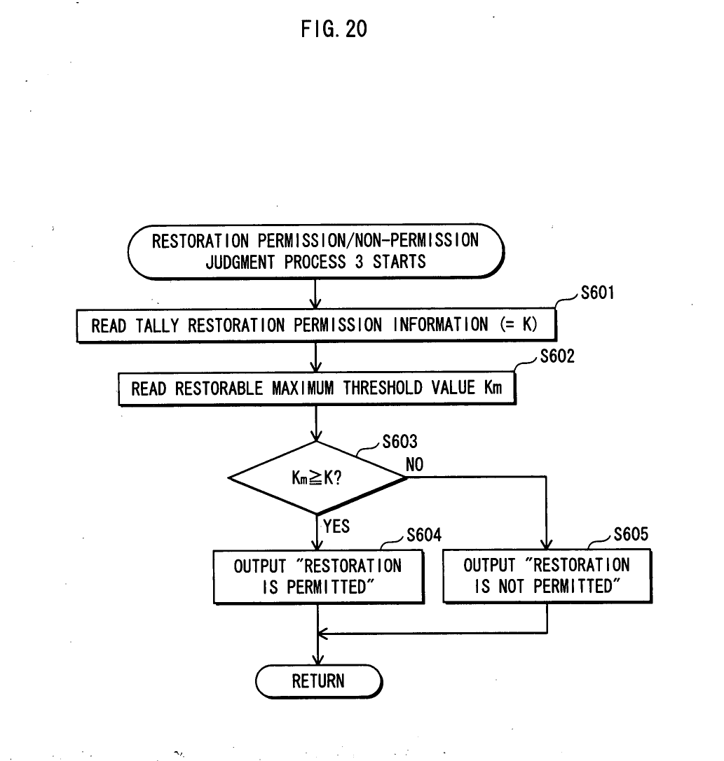

The following describes an operation of the restoration permission/non-permission judgment process 3, with reference to a flowchart shown in FIG. 20. Note that the operation described here is a detail of step S307 in FIG. 16.

The restoration permission/non-permission judgment unit 207 reads a value of the tally restoration permission information 131 included in the tally sub data F₁ (step S601). Note that a value of the restoration threshold value K is set in the tally restoration permission information 131 in the rule 3.

Next, the restoration permission/non-permission judgment unit 207 reads the restorable maximum threshold value Kₘ that is stored in the device characteristic information storage unit 205 (step S602).

The restoration permission/non-permission judgment unit 207 compares the value of the restoration threshold value K that is set in the tally restoration permission information 131 with the value of the restorable maximum threshold value Kₘ.

When Kₘ≧K (“YES” in step S603), the restoration permission/non-permission judgment unit 207 outputs the information indicating “Restoration is permitted” to the data control unit 203 (step S604).

When Kₘ<K (“NO” in step S603), the restoration permission/non-permission judgment unit 207 outputs the information indicating “Restoration is not permitted” to the data control unit 203 (step S605).

Note that in the example shown in FIGS. 5 and 15, K=3 and Kₘ=4. Therefore, the restoration permission/non-permission judgment unit 207 outputs the information indicating “Restoration is permitted” to the data control unit 203 in this example.

(5) Operation of Restoration Permission/Non-Permission Judgment Process 4

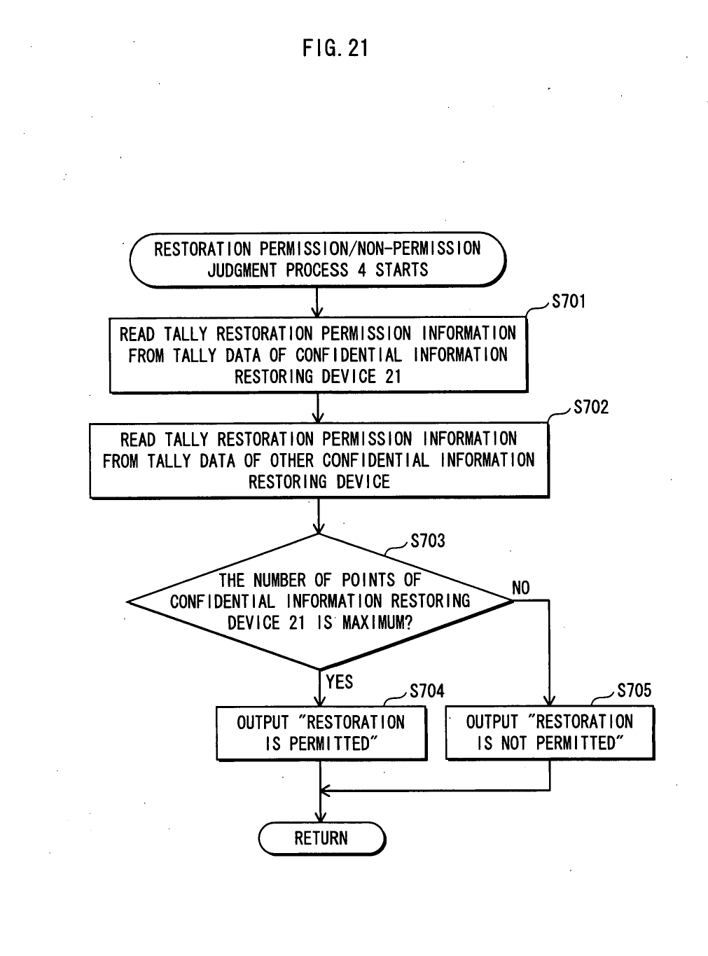

The following describes an operation of the restoration permission/non-permission judgment process 4, with reference to a flowchart shown in FIG. 21. Note that the operation described here is a detail of step S308 in FIG. 16.

The restoration permission/non-permission judgment unit 207 reads the tally restoration permission information 131 from the tally sub data F₁ included in the tally data W₁ of the confidential information restoring device 21 (step S701).

Then, the restoration permission/non-permission judgment unit 207 reads the pieces of tally restoration permission information 141 and 151 from the pieces of tally sub data F₂ and F₃ included in the pieces of tally data W₂ and W₃ of the other confidential information restoring devices (step S702).

The restoration permission/non-permission judgment unit 207 compares the numbers of restoration permission points that are set in the pieces of tally restoration permission information 131, 141, and 151, and judges whether the number of restoration permission points of the confidential information restoring device 21 is maximum.

When the number of restoration permission points of the confidential information restoring device 21 is maximum (“YES” in step S703), the restoration permission/non-permission judgment unit 207 outputs the information indicating “Restoration is permitted” to the data control unit 203 (step S704).

When the number of restoration permission points of the confidential information restoring device 21 is not maximum (“NO” in step S703), the restoration permission/non-permission judgment unit 207 outputs the information indicating “Restoration is not permitted” to the data control unit 203 (step S705).

Note that in the example shown in FIG. 5, the tally restoration permission information 131 is set at “3”, the tally restoration permission information 141 is set at “2”, and the tally restoration permission information 151 is set at “3”. Therefore, the restoration permission/non-permission judgment unit 207 outputs the information indicating “Restoration is permitted” to the data control unit 203 because the number of restoration permission points of the confidential information restoring device 21 is “3” that is the maximum number of restoration permission points out of the three confidential information restoring devices in this example.

(6) Operation of Confidential Information Restoration Process

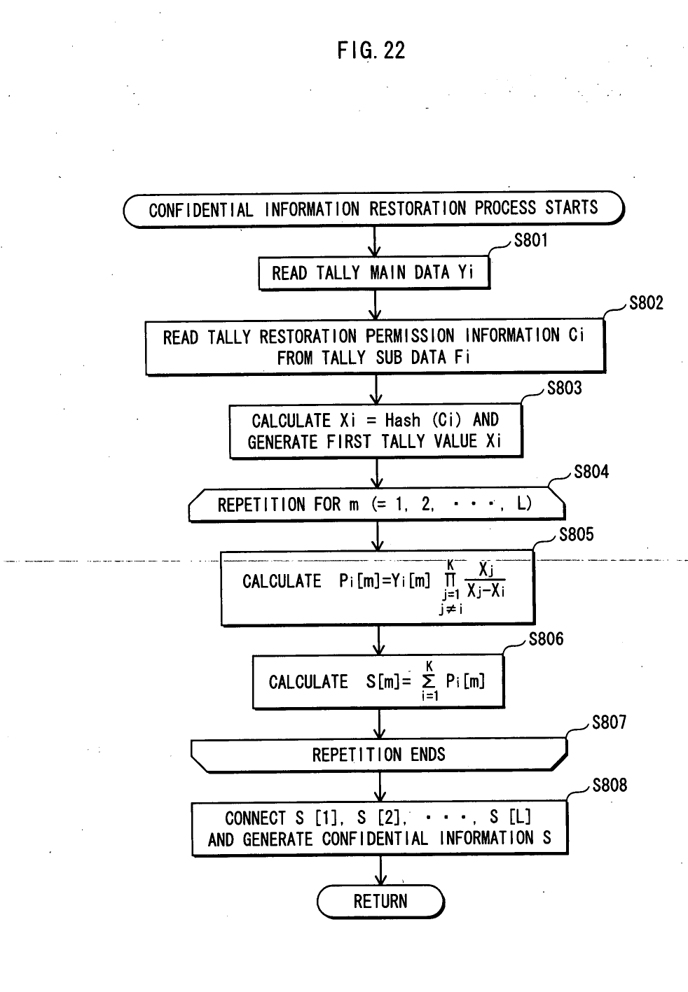

The following describes an operation of the confidential information restoration process, with reference to a flowchart shown in FIG. 22. Note that the operation described here is a detail of step S311 in FIG. 17.

The restoration unit 206 reads the tally main data Y₁ from the tally data W₁ that is stored in the tally data storage unit 202 (step S801). Here, i=1, 2, and 3.

Then, the restoration unit 206 reads the pieces of tally restoration permission information 131, 141, and 151 from the pieces of tally sub data F₁, F₂, and F₃ included in the pieces of tally data W₁, W₂, and W₃ that are stored in the tally data storage unit 202. Here C₁=Tally restoration permission information 131, C₂=Tally restoration permission information 141, and C₃=Tally restoration permission information 151 (step S802).

The restoration unit 206 generates the first tally values X₁=Hash (C₁), X₂=Hash (C₂), and X₃=Hash (C₃) (step S803).

Then, the restoration unit 206 repeats steps S805 and S806 for m=1, 2, . . . , L (steps S804 and S807).

Firstly, the restoration unit 206 calculates Pᵢ [m]=Yᵢ

$$[ m ] {\prod }_{{j = 1}_{j \neq i}}^{K} \frac{Xj}{Xj - Xi}$$

(step S805). Next, the restoration unit 206 calculates

$$S [ m ] = {\sum }_{i = 1}^{K} Pi [ m ]$$

based on Pᵢ [m] (step S806).

Finally, the restoration unit 206 connects S [1], S [2], . . . , S [m] with each other to generate the confidential information S (step S808).

### CONCLUSION

In the above-mentioned embodiment, when the tally restoration permission rule information is set at the “rule 1”, whether the restoration of the confidential information S is permitted can be individually set for each confidential information restoring device.

When the tally restoration permission rule information is set at the “rule 2”, only a confidential information restoring device having the highest priority in the confidential information restoring devices that are involved in a restoration process is permitted to restore the confidential information S. Here, in the case of the “rule 1a”, the following case is likely to occur. If all of the pieces of tally restoration permission information of the confidential information restoring devices that are involved in a restoration process are “non-permission”, no confidential information restoring device can restore the confidential information S. However, in the case of the “rule 2”, any one of the confidential information restoring devices is always a confidential information restoring device having the highest priority. Therefore, the above-mentioned case does not occur.

When the tally restoration permission rule information is set at the “rule 3”, only a confidential information restoring device having processing performance of performing a restoration process of the confidential information S is permitted to restore the confidential information S. Here, the number of calculations required for the (formula 2) and the (formula 3) in the above-mentioned embodiment is as follows. Kˆ2−1 times is required for addition and subtraction K×(K−2) times is required for multiplication, and K×(K−1) times is required for division. From this, it turns out that the number of calculations is determined by the restoration threshold value K. Therefore, in this embodiment, a calculation amount of the confidential information restoration process and a numeric ability of the confidential information restoring device are determined as index values by the value of the restoration threshold value K.

Note that the restorable maximum threshold value Kₘ of each of the confidential information restoring devices is obtained by the number of calculations that can be executed by each of the confidential information restoring devices within a predetermined time, for example. In other words, the restoration threshold value K, which is the number of calculations equal to or less than the number of calculations that can be executed within the predetermined time, is regarded as the restorable maximum threshold value Kₘ.

When the tally restoration permission rule information is set at the “rule 4”, only a confidential information restoring device having the highest priority (device having the highest number of points) in the confidential information restoring devices that are involved in a restoration process is permitted to restore the confidential information S. Also, the priority can be varied in accordance with the past number of restoration. As a result, a case in which only the same confidential information restoring device restores the confidential information S every time can be avoided.

Here, a correspondence relation between the units in the claims and the component parts described in the above-mentioned embodiment will be described.

The tally generation unit in claim 1 corresponds to the tally main data generation unit 103 and the tally data generation unit 104 in the tally generating device 10, and the restoration control information generation unit corresponds to the tally data generation unit 104.

Also, the storage unit in claims 1 and 2 corresponds to the tally data storage unit 202 in the confidential information restoring device 21, the tally collection unit corresponds to the data control unit 203 and the data transmission/reception unit 201, the judgment unit corresponds to the restoration permission/non-permission judgment unit 207, and the restoration unit corresponds to the restoration unit 206.

The device characteristic information storage unit in claim 5 corresponds to the device characteristic information storage unit 205 in the confidential information restoring device 21.

The restoration control information update unit in claim 9 corresponds to the tally sub data update unit 208 in the confidential information restoring device 21.

The tampering detection unit in claim 10 corresponds to the restoration permission/non-permission judgment unit 207 in the confidential information restoring device 21.

The data control unit in claim 11 corresponds to the data control unit 203 in the confidential information restoring device 21.

The tally generation unit in claim 13 corresponds to the tally main data generation unit 103 and the tally data generation unit 104 in the tally generating device 10, the restoration control information generation unit corresponds to the tally data generation unit 104, and the distribution unit corresponds to the tally data transmission unit 105.

The tampering detection value generation unit in claim 18 corresponds to the tally main data generation unit 103 in the tally generating device 10.

### OTHER MODIFICATION

Up to now, the present invention has been described specifically through the above-mentioned embodiment. However, the technical scope of the present invention is not limited to the above-described embodiment. For example, the following are modifications.

(1) In the above-mentioned embodiment, as shown in FIG. 4, the tally restoration permission information is 128-bit data including a significant information bit size and random number data. Also, the tally data generation unit 104 generates the first tally value by calculating a hash value corresponding to the tally restoration permission information of the 128-bit data. However, the present invention is not limited to this structure. The tally data generation unit 104 may calculate a hash value only for the significant information to generate the first tally value.

(2) In the above-mentioned embodiment, the tally sub data includes the restoration threshold value K, but it is not essential for the present invention. The tally sub data does not need to include the restoration threshold value K if each of the confidential information restoring devices included in a system has been informed of the number (value of the restoration threshold value K) of pieces of tally data required for the restoration of the confidential information S in advance, so that each of the confidential information restoring devices can recognize how many pieces of tally data should be obtained from the other confidential information restoring device.

(3) In the above-mentioned embodiment, when the tally restoration permission rule information 120c indicates the “rule 2” and the “rule 4”, only a confidential information restoring device having the highest priority and the highest number of points is permitted to restore the confidential information S. However, the present invention is not limited to this construction, and the following construction may be used. For example, the predetermined number of confidential information restoring devices such as two confidential information restoring devices in descending order of priority and the number of points may be permitted to restore the confidential information S.

Also, when the tally restoration permission rule information 120c indicates the “rule 4”, the construction of the present invention is not limited to the above-mentioned construction in which only a confidential information restoring device having the highest number of points is permitted to restore the confidential information S, but a construction in which any confidential information restoring device is permitted to restore the confidential information S, regardless of small or large of the number of points may be used. In this case, the number of point indicates the remaining number of permitting the restoration process for each of the confidential information restoring devices.

Moreover, in the above-mentioned embodiment, when the tally restoration permission rule information 120c indicates the “rule 3”, a value of the restoration threshold value K is set in each of the pieces of tally restoration permission information, as information indicating a numeric ability required for the restoration process of the confidential information S. However, the number of clocks of a CPU and a memory size may be used for indicating the numeric ability of each of the confidential information restoring devices in the present invention.

Furthermore, when the tally restoration permission rule information 120c indicates the “rule 3”, the present invention is not limited to the numeric ability of each of the confidential information restoring devices, and a construction in which other device characteristic of the confidential information restoring device is indicated may be used. For example, the following construction may be used. If the confidential information S is image data, resolution of a display device included in each of the confidential information restoring devices is used as an evaluation standard, and a confidential information restoring device including a display device having resolution equal to or smaller than a predetermined resolution is prohibited to restore the confidential information S. Also, if the confidential information S is moving image data, a reproduction ability of moving image data included in each of the confidential information restoring devices is used as an evaluation standard, and a confidential information restoring device, in which an error such as a data frame might occur when the confidential information S is reproduced, is prohibited to restore the confidential information S.

Also, whether the confidential information restoring device has a predetermined ability may be used as an evaluation standard. For example, if a confidential information restoring device having a data replication ability is prohibited to restore the confidential information S replication of the confidential information S without permission can be suppressed and the confidential information S can be protected.

Moreover, in the above-mentioned embodiment, when the tally restoration permission rule information 120c indicates the “rule 4”, the tally sub data update unit 208 in the confidential information restoring device 21 subtracts the number of point of the confidential information restoring device 21 by one. However, the present invention is not limited to this construction. The present invention may have a construction in which the number of points corresponding to a confidential information restoring device other than a confidential information restoring device that restores the confidential information S is increased. According to this construction, the same effect as the above-mentioned embodiment can be obtained.

Furthermore, the present invention may have a construction in which the number of points to be increased or decreased is weighted for each confidential information restoring device. According to this construction, the confidential information restoring devices can be managed by distinguishing a confidential information restoring device that tends not to be prohibited the restoration process of the confidential information S from a confidential information restoring device that tends to be prohibited the restoration process of the confidential information S.

Also, the present invention may have a construction in which a degree of increasing or decreasing the number of points can be varied for each confidential information, based on an intention of a creator of tally data. Because of this construction, the degree of increasing or decreasing the number of points can be adjusted for each confidential information, based on the intention of the creator of the tally data. Note that in this case, information of the number of points to be increased or decreased is required to be given to the confidential information restoring device, along with the tally main data. This can be realized by causing the tally sub data to include the information of the number of points to be increased or decreased.

Moreover, in the above-mentioned embodiment, when the tally restoration permission rule information 120c indicates the “rule 4”, the tally sub data update unit 208 in the confidential information restoring device 21 updates only the tally sub data thereof. However, the present invention is not limited to this construction, and may have the following construction. The tally sub data update unit 208 updates the tally sub data of the confidential information restoring device 21, and instructs the tally sub data update unit of other confidential information restoring device to update the corresponding tally sub data, via the data transmission/reception unit 201.

In this case, the tally sub data is updated in all of the confidential information restoring devices. Therefore, a state of the tally sub data corresponding to the tally data that is generated from the same confidential information can be synchronized in a system.

(4) In the above-mentioned embodiment, the tally generating device 10 generates the first tally value Xᵢ which is 1-byte data by calculating a hash value for each of the pieces of tally restoration permission information Cᵢ (i=1, 2, . . . , 5) which is 128-bit data. Then, the tally generating device 10 distributes the tally main data Yᵢ that is generated using the first tally value Xᵢ to each of the confidential information restoring devices. However, the first tally value Xᵢ is not distributed.

The present invention has this construction in order to reduce a transmitted data amount, because the first tally value Xᵢ can be generated on each of the confidential information restoring devices side, based on the tally restoration permission information Cᵢ.

However, the present invention may have a construction in which, in the system in the present invention, the first tally value Xᵢ itself that is generated in the first tally value generation unit 182 is included in the tally main data Yᵢ, and the first tally value Xᵢ included in the tally main data Yᵢ is transmitted to each of the confidential information restoring devices.

Also, in each of the confidential information restoring devices, the following construction may be used in the restoration permission/non-permission judgment process by the restoration permission/non-permission judgment unit 207. Before the restoration permission/non-permission judgment process using the tally restoration permission information Cᵢ, a one-way hash function is calculated for the tally restoration permission information Cᵢ which is included in the tally sub data Fᵢ, and the calculated value is compared with the first tally value Xᵢ included in the tally main data Yᵢ, in order to judge whether the tally restoration permission information Cᵢ is tampered.

When detecting that the tally restoration permission information Cᵢ is tampered, the restoration permission/non-permission judgment unit 207 may end the restoration process of the confidential information S, and when not detecting that the tally restoration permission information Cᵢ is tampered, the restoration permission/non-permission judgment unit 207 may start the restoration permission/non-permission judgment process that is described in the above-mentioned embodiment. Note that a calculation method that is used for a tampering detection process is not limited to the calculation method for calculating the one-way hash function, and encryption or the like may be used.

Because of this construction, an unauthorized confidential information restoration process can be prevented.

Here, in the construction in which the first tally value Xᵢ is not transmitted to the confidential information restoring device as in the above-mentioned embodiment, the tampering detection process of the tally restoration permission information by comparing the hash values cannot be performed. However, if the tally restoration permission information is tampered, the confidential information restoring device cannot obtain the correct first tally value Xᵢ, and restore the correct confidential information S. As a result, an unauthorized restoration of the confidential information S can be prevented.

Moreover, in the above-mentioned embodiment, if the tally restoration permission information Cᵢ is 1-byte information, a value of the tally restoration permission information Cᵢ itself may be used as the first tally value Xᵢ. In this case, the confidential information S cannot be correctly restored if the tally restoration permission information Cᵢ is tampered, as in the case in which Hash (Cᵢ) is the first tally value Xᵢ.

Furthermore, the first tally value Xᵢ may be generated without using the tally restoration permission information Cᵢ. For example, by generating a random number, and the generated random number is used as the first tally value Xᵢ. Note that in this case, the first tally value Xᵢ is required to be included in the tally main data Yᵢ to be used for the restoration of the confidential information S.

Also, whether the tally restoration permission information Cᵢ is used for generating the first tally value Xᵢ can be switched for each i as follows. For example, the first tally value Xᵢ that is generated using the tally restoration permission information Cᵢ is used for certain i, and the first tally value Xᵢ that is generated using a random number or the like is used for certain i.

(5) In the above-mentioned embodiment, each of the confidential information restoring devices transmits the whole tally data including the tally main data and the tally sub data to other confidential information restoring device with each other, during the restoration permission/non-permission judgment process. However, the present invention is not limited to this construction.

The present invention may have a construction in which the confidential information restoring device transmits only the tally sub data that is required for the restoration permission/non-permission judgment process firstly, and when judging that “Restoration is permitted” in the restoration permission/non-permission judgment process, the confidential information restoring device requests the tally main data to other confidential information restoring device. Because of this construction, transmission/reception of unnecessary data can be suppressed when judging that “Restoration is not permitted”, and a data amount that is transmitted or received between the confidential information restoring devices can be reduced.

(6) Also, in the above-mentioned embodiment, the tally generating device 10 receives the tally generation instruction information from outside, and generates the ally sub data corresponding to each of the confidential information restoring devices, based on the data that is extracted from the tally generation instruction information. However, the present invention is not limited to this construction. The present invention may have a construction in which the tally generating device 10 stores the tally generation instruction information in advance.

Moreover, the present invention may have the following construction. When one of the confidential information restoring devices restores the confidential information, the tally generating device 10 is notified that the confidential information restoring device restores the confidential information. When receiving the notification from the one of the confidential information restoring devices, the tally generating device 10 generates the tally sub data that reflects the notification.

With this construction, the tally generating device 10 generates tally sub data that reflects an intention of the tally generating device 10 to make it possible to control an operation of each of the confidential information restoring devices.

For example, the tally generating device 10 can perform control by generating the tally sub data, which makes it difficult to restore the confidential information afterward, for the confidential information restoring device that restored the confidential information in the past.

(7) In the above-mentioned embodiment, a memory card is indicated as a concrete example of the confidential information restoring device 25. However, the confidential information restoring device 25 is not limited to the memory card, and other recording medium such as an optical disk, a magnetic disk, or the like may be used.

Note that in the case of the optical disk, the optical disk sometimes a recordable disk that is incapable of overwriting data. In this case, if the tally data that is received from other confidential information restoring device is temporarily stored in the tally data storage unit 202 as in the above-mentioned embodiment, a remaining disk capacity is reduced each time the tally data is restored. Also, in the case of a read-only recording medium such as a BD-ROM or the like, the tally data that is received from other confidential information restoring device cannot be temporarily stored in the confidential information restoring device. Therefore, if the confidential information restoring device 25 is the recordable or read-only recording medium, it is desirable that a confidential information restoring device that uses information of the confidential information restoring device 25 offers a part of a memory as the tally data storage unit 202.

Also, the “rule 4” that involves the update of the number of points is not suitable for the recordable or read-only recording medium. Therefore, if the confidential information restoring device 25 is the recordable or read-only recording medium, the process may be interrupted when the tally restoration permission rule information indicates the “rule 4”. However, in the case of the recordable recording medium, the “rule 4” may be applied if reduction of a free space caused by the update of the number of points is allowed.

Moreover, in the above-mentioned embodiment, the present invention has only a construction in which a memory card which is an example of the confidential information restoring device 25 corresponds to the tally data storage unit 202, the device identification information storage unit 204, and the device characteristic information storage unit 205. However, the present invention is not limited to this construction, and may have a construction in which other component parts can be realized on the memory card by adding an IC chip or the like which performs a predetermined process in the memory card. In this case, the confidential information restoring device 25 receives electric power supply or the like from a confidential information restoring device which is connected to the confidential information restoring device 25, but can perform the restoration process of the confidential information itself in the confidential information restoring device 25. This can reduce the possibility that the confidential information is leaked.

(8) In the above-mentioned embodiment, the tally restoration permission information is assigned to each of the confidential information restoring devices one by one. However, the present invention is not limited to this construction, and may have a construction in which a plurality of pieces of tally restoration permission information are assigned to one confidential information restoring device. In this case, the confidential information restoring device performs the process using one of the plurality of pieces of tally restoration permission information, in accordance with a predetermined standard. More specifically, tally restoration permission information having the highest priority may be used in the case of the “rule 2”.

Also, in this case, the confidential information restoring device may use some of the plurality of pieces of tally restoration permission information, that are assigned to the confidential information restoring device, as information that is offered to external, and use some of the plurality of pieces of tally restoration permission information as information that is used for the process of the confidential information restoring device. Such control is effective for a case in which both restoration by a confidential information restoring device that gives the tally data and restoration by other confidential information restoring device that collects the tally data are permitted as much as possible.

In other words, in an example in the case of the “rule 2”, when restoration by a specific confidential information restoring device to which the tally restoration permission information is assigned is needed to be permitted as much as possible, higher priority is required to be given to the specific confidential information restoring device. However, in this case, if other confidential information restoring device tries to restore confidential data using the tally data that is collected from the specific confidential information restoring device, it tends to be judged that the restoration by other confidential information restoring device is not permitted because of the higher priority. Therefore, low priority is given as tally restoration permission information that is outputted to external in such, a case. As a result, since the priority of the tally restoration permission information included in the tally data becomes low, other confidential information restoring device that performs the restoration of the confidential information by collecting the tally data tends to be permitted the restoration.

Note that contrary to the above-mentioned construction, it is possible to perform control so that both the restoration of the confidential information by the specific confidential information restoring device and the restoration by other confidential information restoring device that receives the tally data from the specific confidential information restoring device becomes difficult, by making a condition of the tally restoration permission information that is supplied to other confidential information restoring device high, and making a condition of the tally restoration permission information that is used by the specific confidential information restoring device low. Also, although the example in the case of the “rule 2” is described here, the same control can be performed in the case of other rules.

(9) In the above-mentioned embodiment, the confidential information restoring device that is permitted to perform the restoration process of the confidential information S is controlled by establishing the four rules from the rule 1 to rule 4. However, the four rules from the rule 1 to rule 4 are just a concrete example after all. Therefore, the present invention is not limited to the above-mentioned embodiment in which the four rules from the rule 1 to rule 4 are used, and may have a construction in which whether or not to permit the restoration of the confidential information is controlled by a condition indicating whether or not to permit the restoration of the confidential information for each of the confidential information restoring devices.

(10) In the above-mentioned embodiment, the present invention is described using the concrete example in which the confidential information restoring device is realized by a mobile phone, a personal computer, or the like is used. However, the confidential information restoring device of the present invention may be realized by a small-scale module such as a wireless tag, a sensor node in a sensor network, or the like.

The sensor network is a system that forms a network using an ultracompact sensor (sensor node) having a communication function, and collects data that is obtained by each sensor. The sensor node is not fixed, but is capable of moving by being moved because a user, a car, or the like holds the sensor node, and a formed network is dynamically varied.

The present invention may have a construction in which a plurality of pieces of tally data are generated from a secret key that is held by the wireless tag and the sensor node, and the generated pieces of tally data are divided and shared by the wireless tag and the sensor node.

In a network system in which the wireless tag, the sensor node, or the like are used, the wireless tag and the sensor node are required to hold a secret key that is used for an authentication process, encryption communication between the wireless tags and between the sensor nodes, or the like. However, because such small-scale modules are low cost, the modules have only a relatively low tamper resistant. Therefore, security of the secret key can be protected by sharing the secret key using the present invention.

(11) The electronic tally method that is used in the above-mentioned embodiment is just an example after all, and other electronic tally method can be applied by the same construction.

(12) The present invention may be realized by methods described in the above-mentioned embodiment. Also, the present invention may be realized by a computer program executed on a computer for realizing these methods, or by a digital signal representing the computer program.

Also, the present invention may be realized by a computer-readable recording medium on which the computer program or the digital signal is recorded. Examples of the computer-readable recording medium include a flexible disk, a hard disk, a CD-ROM, an MO, a DVD, a DVD-ROM, a DVD-RAM, BD (Blu-ray Disc), and a semiconductor memory. Also, the present invention may be realized by the computer program or the digital signal recorded on such recording media.

Further, the present invention may be realized by the computer program or the digital signal transmitted via an electric communication line, a wired/wireless communication line, a network such as the Internet, or data broadcast.

Moreover, the present invention may be realized by a computer system including a microprocessor and a memory. The memory may store the computer program, and the microprocessor may operate in accordance with the computer program.

The computer program or the digital signal may be transferred as being recorded on the recording medium, or via the network or the like, so that the computer program or the digital signal may be executed by another independent computer system.

(13) A part or all of the component parts that construct each device of the present invention may be constructed by one system LSI (Large Scale Integration). The system LSI is a highly functional LSI that is manufactured by accumulating a plurality of component parts on one chip. More specifically, the system LSI is a computer system including a microprocessor, a ROM, a RAM, or the like. A computer program is stored in the RAM. Because the microprocessor operates in accordance with the computer program, the system LSI achieves a function thereof. Also, a method of circuit integration is not limited to LSI, and can be realized by a dedicated circuit. A FPGA (Field Programmable Gate Array) which is programmable after manufacturing LSI, and a reconfigurable processor which can reconfigure a connection and a setting of a circuit cell in LSI may be used.

Moreover, if a technology of circuit integration which replaces LSI comes along because of progress of a semiconductor technology or other technologies which derive from the semiconductor technology, integration of a functional block may rightly be performed using the technology. An application of a biotechnology may be regarded as the possibility.

(14) A part or all of the component parts that construct each device of the present invention may be constructed by an IC card which is removable from each device or a single module. The IC card or the module is a computer system which is constructed by a microprocessor, a ROM, a RAM, or the like. The IC card or the module may include the highly functional LSI. Because the microprocessor operates in accordance with the computer program, the IC card or the module achieves a function thereof. The IC card or the module may have a tamper resistant.

(15) The above-mentioned embodiment and the modifications can be freely combined.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A confidential information protection system that includes a tally generating device and a plurality of terminal devices, and divides up and holds confidential information among the plurality of terminal devices,
the tally generating device comprising:
a tally generation unit operable to generate a plurality of electronic tallies from the confidential information; and
a restoration control information generation unit operable to generate, for each of the plurality of terminal devices, restoration control information that indicates a condition relating to restoration of the confidential information by the terminal device, and
each of the plurality of terminal devices comprising:
a storage unit operable to store therein one of the plurality of electronic tallies and the corresponding restoration control information generated by the tally generating device;
a tally collection unit operable to collect a required number of electronic tallies;
a judgment unit operable to judge whether or not the restoration of the confidential information is permitted, based on the corresponding restoration control information, and
a restoration unit operable to, only when the judgment unit judges that the restoration of the confidential information is permitted, restore the confidential information from the one of the plurality of electronic tallies stored in the storage unit and the required number of electronic tallies collected by the tally collection unit.

2. A confidential information restoring device for restoring confidential information from a plurality of electronic tallies that are generated from the confidential information, the confidential information restoring device comprising:
a storage unit operable to store therein one of the plurality of electronic tallies and restoration control information generated by a tally generating device, the restoration control information indicating a condition relating to restoration of the confidential information;
a tally collection unit operable to collect a required number of electronic tallies;
a judgment unit operable to judge whether or not the restoration of the confidential information is permitted, based on the restoration control information stored in the storage unit; and
a restoration unit operable to, only when the judgment unit judges that the restoration of the confidential information is permitted, restore the confidential information from the one of the plurality of electronic tallies stored in the storage unit and the required number of electronic tallies collected by the tally collection unit.

3. The confidential information restoring device of claim 2, wherein
the tally collection unit obtains, from each of a same number of other confidential information restoring devices as the required number, an electronic tally and restoration control information which the other confidential information restoring device acquired from the tally generating device, and
the restoration unit restores the confidential information using the one of the plurality of electronic tallies and the restoration control information stored in the storage unit, and the electronic tally and the restoration control information obtained by the tally collection unit.

4. The confidential information restoring device of claim 3, wherein
information that indicates whether or not to permit the restoration of the confidential information is set in the restoration control information stored in the storage unit, and
the judgment unit judges that the restoration of the confidential information is permitted when the restoration control information indicates permission of the restoration, and judges that the restoration of the confidential information is not permitted when the restoration control information indicates non-permission of the restoration.

5. The confidential information restoring device of claim 3, wherein
information that indicates a characteristic of a device that is permitted to restore the confidential information is set in the restoration control information stored in the storage unit, and
the confidential information restoring device further comprises:
a device characteristic storage unit operable to store device characteristic information that indicates a characteristic of the confidential information restoring device, wherein
the judgment unit reads the device characteristic information, judges that the restoration of the confidential information is permitted when the read device characteristic information satisfies the characteristic indicated by the restoration control information, and judges that the restoration of the confidential information is not permitted when the read device characteristic information does not satisfy the characteristic indicated by the restoration control information.

6. The confidential information restoring device of claim 5, wherein
the characteristic indicated by the restoration control information indicates processing performance that is required for the restoration of the confidential information, and
the device characteristic information indicates processing performance of the confidential information restoring device.

7. The confidential information restoring device of claim 3, wherein
the judgment unit compares the restoration control information stored in the storage unit with the restoration control information obtained by the tally collection unit to perform the judgment.

8. The confidential information restoring device of claim 7, wherein
information that indicates a priority of performing the restoration of the confidential information in a plurality of confidential information restoring devices that hold the plurality of electronic tallies is set in the restoration control information stored in the storage unit, and
the judgment unit judges that the restoration of the confidential information is permitted when the priority indicated by the restoration control information stored in the storage unit is higher than a priority indicated by the restoration control information obtained by the tally collection unit, and judges that the restoration of the confidential information is not permitted when the priority indicated by the restoration control information stored in the storage unit is lower than the priority indicated by the restoration control information obtained by the tally collection unit.

9. The confidential information restoring device of claim 8, further comprising:
a restoration control information update unit operable to, when the judgment unit judges that the restoration of the confidential information is permitted, update the priority indicated by the restoration control information stored in the storage unit.

10. The confidential information restoring device of claim 3, receiving a tampering detection value from the tally generating device, the tampering detection value being generated by performing a predetermined operation on the restoration control information, wherein
the judgment unit judges whether the restoration control information has been tampered with, by using the tampering detection value, and judges that the restoration of the confidential information is not permitted when the tampering of the restoration control information is detected.

11. The confidential information restoring device of claim 3, wherein
each of the plurality of electronic tallies is information generated by performing a secret sharing scheme that uses a plurality of pieces of restoration control information on the confidential information, and
the restoration unit restores the confidential information from the plurality of electronic tallies, using the restoration control information stored in the storage unit and the restoration, control information obtained by the tally collection unit.

12. The confidential information restoring device of claim 2, further comprising:
a data control unit operable to, when the judgment unit judges that the restoration of the confidential information is not permitted, discard the required number of electronic tallies collected by the tally collection unit.

13. The confidential information restoring device of claim 2, wherein
the tally collection unit collects the required number of electronic tallies when the judgment unit judges that the restoration of the confidential information is permitted.

14. A tally generating device comprising:
a tally generation unit operable to generate a plurality of electronic tallies from confidential information;
a restoration control information generation unit operable to generate, for each of a plurality of terminal devices that are distribution targets of the plurality of electronic tallies, restoration control information that indicates a condition relating to restoration of the confidential information by the terminal device; and
a distribution unit operable to distribute each of the plurality of electronic tallies and the corresponding restoration control information to each of the terminal devices.

15. The tally generating device of claim 14, wherein
the restoration control information generation unit generates the restoration control information based on a number of the plurality of electronic tallies to be generated, a required number of electronic tallies for the restoration of the confidential information, and tally generation instruction information including the condition, and
the tally generation unit generates the plurality of electronic tallies based on the confidential information, the tally generation instruction information, and the restoration control information.

16. The tally generating device of claim 15, wherein
the restoration control information generation unit generates the restoration control information that indicates whether or not to permit the restoration of the confidential information in each of the plurality of terminal devices.

17. The tally generating device of claim 15, wherein
the restoration control information generation unit generates the restoration control information that indicates a priority of the restoration of the confidential information in each of the plurality of terminal devices.

18. The tally generating device of claim 15, wherein
the restoration control information generation unit generates the restoration control information that indicates a characteristic of a device that is permitted to restore the confidential information.

19. The tally generating device of claim 18, wherein
the characteristic indicated by the restoration control information is processing performance that is required for the restoration of the confidential information.

20. The tally generating device of claim 19, wherein
the restoration control information generation unit generates the restoration control information which is a value of the required number of electronic tallies for the restoration of the confidential information included in the tally generation instruction information.

21. The tally generating device of claim 15, further comprising:
a tampering detection value generation unit operable to perform a predetermined operation on the restoration control information to generate a tampering detection value corresponding to the restoration control information; wherein
the distribution unit distributes the tampering detection value, in addition to each of the plurality of electronic tallies and the restoration control information, to each of the plurality of terminal devices.

22. The tally generating device of claim 14, wherein
the tally generation unit generates the plurality of electronic tallies based on the plurality of pieces of restoration control information generated by the restoration control information generation unit and the confidential information.

23. The tally generating device of claim 22, wherein
the tally generation unit performs a secret sharing scheme that uses the plurality of pieces of restoration control information on the confidential information to generate the plurality of electronic tallies.

24. A confidential information restoration method that is used in a confidential information restoring device for restoring confidential information from a plurality of electronic tallies that are generated from the confidential information, the confidential information restoring device comprising:
a storage unit operable to store therein one of the plurality of electronic tallies and restoration control information generated by a tally generating device, the restoration control information indicating a condition relating to restoration of the confidential information, and
the confidential information restoration method comprising:
a tally collection step of collecting a required number of electronic tallies;
a judgment step of judging whether or not the restoration of the confidential information is permitted, based on the restoration control information is stored in the storage unit; and
a restoration step of, only when the judgment step judges that the restoration of the confidential information is permitted, restoring the confidential information from the one of the plurality of electronic tallies stored in the storage unit and the required number of electronic tallies collected by the tally collection step.

25. A computer program that is used in a confidential information restoring device for restoring confidential information from a plurality of electronic tallies that are generated from the confidential information, the confidential information restoring device comprising:
a storage unit operable to store therein one of the plurality of electronic tallies and restoration control information generated by a tally generating device, the restoration control information indicating a condition relating to restoration of the confidential information, and
the computer program comprising:
a tally collection step of collecting a required number of electronic tallies;
a judgment step of judging whether or not the restoration of the confidential information is permitted, based on the restoration control information stored in the storage unit; and
a restoration step of, only when the judgment step judges that the restoration of the confidential information is permitted, restoring the confidential information from the one of the plurality of electronic tallies stored in the storage unit and the required number of electronic tallies collected by the tally collection step.

26. A computer-readable recording medium that records a computer program used in a confidential information restoring device for restoring confidential information from a plurality of electronic tallies that are generated from the confidential information, the confidential information restoring device comprising:
a storage unit operable to store therein one of the plurality of electronic tallies and restoration control information generated by a tally generating device, the restoration control information indicating a condition relating to restoration of the confidential information, and
the computer program comprising:
a tally collection step of collecting a required number of electronic tallies;
a judgment step of judging whether or not the restoration of the confidential information is permitted, based on the restoration control information stored in the storage unit; and
a restoration step of, only when the judgment step judges that the restoration of the confidential information is permitted, restoring the confidential information from the one of the plurality of electronic tallies stored in the storage unit and the required number of electronic tallies collected by the tally collection step.

27. An integrated circuit that is used in a confidential information restoring device for restoring confidential information from a plurality of electronic tallies that are generated from the confidential information, the integrated circuit comprising:
a storage unit operable to store therein one of the plurality of electronic tallies and restoration control information generated by a tally generating device, the restoration control information indicating a condition relating to a restoration of the confidential information;
a tally collection unit operable to collect a required number of electronic tallies;
a judgment unit operable to judge whether or not the restoration of the confidential information is permitted, based on the restoration control information stored in the storage unit; and
a restoration unit operable to, only when the judgment unit judges that the restoration of the confidential information is permitted, restore the confidential information from the one of the plurality of electronic tallies stored in the storage unit and the required number of electronic tallies collected by the tally collection unit.

28. A tally generation method that is used in a tally generating device, the tally generation method comprising:
a tally generation step of generating a plurality of electronic tallies from confidential information;
a restoration control information generation step of generating, for each of a plurality of terminal devices that are distribution targets of the plurality of electronic tallies, restoration control information that indicates a condition relating to restoration of the confidential information by the terminal device; and
a distribution step of distributing each of the plurality of electronic tallies and the restoration control information to the corresponding terminal device.

29. A computer program that is used in a tally generating device, the computer program comprising:
a tally generation step of generating a plurality of electronic tallies from confidential information;
a restoration control information generation step of generating, for each of a plurality of terminal devices that are distribution targets of the plurality of electronic tallies, restoration control information that indicates a condition relating to restoration of the confidential information by the terminal device; and
a distribution step of distributing each of the plurality of electronic tallies and the restoration control information to the corresponding terminal device.

30. A computer-readable recording medium that records a computer program used in a tally generating device, the computer program comprising:
a tally generation step of generating a plurality of electronic tallies from confidential information;
a restoration control information generation step of generating, for each of a plurality of terminal devices that are distribution targets of the plurality of electronic tallies, restoration control information that indicates a condition relating to restoration of the confidential information by the terminal device; and
a distribution step of distributing each of the plurality of electronic tallies and the restoration control information to the corresponding terminal device.

31. An integrated circuit that is used in a tally generating device, comprising:
a tally generation unit operable to generate a plurality, of electronic tallies from confidential information;
a restoration control information generation unit operable to generate, for each of a plurality of terminal devices that are distribution targets of the plurality of electronic tallies, restoration control information that indicates a condition relating to restoration of the confidential information by the terminal device; and
a distribution unit operable to distribute each of the plurality of electronic tallies and the restoration control information to the corresponding terminal device.
